(19) United States
(12) Patent Application Publication
(10) Pub. No.: US 2019/0088108 A1
(43) Pub. Date: Mar. 21, 2019

(54) CAMERA TAMPERING DETECTION

(71) Applicant: QUALCOMM Incorporated, San Diego, CA (US)

(72) Inventors: Bala Krishna Mandadi, Hyderabad (IN); Chandan Gera, Hyderabad (IN)

(21) Appl. No.: 15/707,913

(22) Filed: Sep. 18, 2017

(51) Int. Cl. G08B 29/04; G06T 7/20; G08B 13/196

(52) U.S. Cl. CPC G08B 29/046; G03B 17/18; G08B 13/1961; G06T 7/20

(57) ABSTRACT

Methods and devices for determining camera tampering are disclosed. In some aspects, a device includes one or more processors and a memory coupled to the one or more processors. The memory includes instructions that, when executed by the one or more processors, cause the device to determine a first sum vector of intensity values from a first image frame captured by a camera at a first time, determine a second sum vector of intensity values from a second image frame captured by the camera at a second time after the first time, compare the first sum vector to the second sum vector, and detect a tampering of the camera based on the comparison.

### TECHNICAL FIELD

The present disclosure relates generally to image processing, and specifically to detecting camera tampering.

### BACKGROUND

One or more cameras may be used to observe an area or scene. For example, secured areas (such as businesses, homes, private property, and so on) may include one or more mounted security cameras, observation areas (such as natural parks, zoological parks, wilderness areas, and so on) may include one or more cameras for observing natural landmarks or animals, and areas of public interest (such as construction sites, traffic cameras, and so on) may include one or more mounted cameras to record a scene for public viewing.

A camera may be tampered with (such as being moved, covered, or placed out of focus) so that the camera no longer satisfactorily captures an intended scene. In one example, high winds, animal interference, or a person may move the camera so that the camera's direction of view is changed. In another example, debris or a covering may fall on the camera lens to obstruct the camera's view. In yet another example, water, ice, or a film may be on the camera lens so that the recorded scene is out of focus. In an additional example, a person may manually move the camera or adjust the focal length of the camera lens to deliberately place the scene out of focus for the camera.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure are directed to methods and devices for detecting camera tampering. In some aspects, a device is disclosed that includes one or more processors and a memory coupled to the one or more processors. The memory includes instructions that, when executed by the one or more processors, cause the device to determine a first sum vector of intensity values from a first image frame captured by a camera at a first time, determine a second sum vector of intensity values from a second image frame captured by the camera at a second time after the first time, compare the first sum vector to the second sum vector, and detect a tampering of the camera based on the comparison.

In another aspect, a method is disclosed for detecting camera tampering. The method includes determining a first sum vector of intensity values from a first image frame captured by a camera at a first time, determining a second sum vector of intensity values from a second image frame captured by the camera at a second time after the first time, comparing the first sum vector to the second sum vector, and detecting a tampering of the camera based on the comparison.

In another aspect, a non-transitory computer-readable storage medium is disclosed. The non-transitory computer-readable storage medium may store one or more programs containing instructions that, when executed by one or more processors of a device, cause the device to perform a number of operations. The number of operations includes determining a first sum vector of intensity values from a first image frame captured by a camera at a first time, determining a second sum vector of intensity values from a second image frame captured by the camera at a second time after the first time, comparing the first sum vector to the second sum vector, and detecting a tampering of the camera based on the comparison.

In another aspect, a device is disclosed. The device may include means for determining a first sum vector of intensity values from a first image frame captured by a camera at a first time, means for determining a second sum vector of intensity values from a second image frame captured by the camera at a second time after the first time, means for comparing the first sum vector to the second sum vector, and means for detecting a tampering of the camera based on the comparison.

### BRIEF DESCRIPTION OF THE DRAWINGS

Aspects of this disclosure are illustrated by way of example, and not by way of limitation, in the figures of the accompanying drawings and in which like reference numerals refer to similar elements.

FIG. 1A is an illustration depicting example camera movement.

FIG. 1B is an illustration depicting example camera obstruction.

FIG. 1C is an illustration depicting example light obstruction of a camera.

FIG. 1D is an illustration depicting example blurring of a camera image.

FIG. 2 is a block diagram of an example device for detecting camera tampering.

FIG. 3 is an illustration depicting an example row sum vector and an example column sum vector of a camera image.

FIG. 4 is an illustrative flow chart depicting an example operation for detecting camera tampering.

FIG. 5A is an illustration depicting an example change in a column sum vector as a result of camera movement.

FIG. 5B is an illustration depicting an example change in a column sum vector as a result of camera obstruction.

FIG. 5C is an illustration depicting an example change in a column sum vector as a result of light obstruction of a camera.

FIG. 5D is an illustration depicting an example change in a column sum vector as a result of blurring of a camera image.

FIG. 6 is an illustrative flow chart depicting an example operation for comparing one or more segments of a first sum vector to the corresponding segment of a second sum vector.

FIG. 7 is an illustration depicting an example segmentation of a first column sum vector and a second column sum vector.

FIG. 8 is an illustration depicting example differences in intensity values between a number of segments of a sum vector.

FIG. 9A is an illustrative flow chart depicting an example operation for detecting camera tampering.

FIG. 9B is an illustrative flow chart depicting an example operation for comparing non-flat field segments of a first sum vector with segments of a second sum vector.

FIG. 9C is an illustrative flow chart depicting an example operation for comparing non-flat field segments of a first sum vector with non-flat field segments of a second sum vector.

FIG. 10 is an illustration depicting example non-flat field segments of a first sum vector to be compared to corresponding segments of a second sum vector.

FIG. 11 is an illustration depicting example non-flat field segments of a first sum vector and example non-flat field segments of a second sum vector for comparing the number of non-flat field segments.

FIG. 12A is an illustration depicting an example segmentation of a row sum vector and an example segmentation of a column sum vector of a captured image frame.

FIG. 12B is an illustration depicting example non-flat field segments of a row sum vector and example non-flat field segments of a column sum vector of an image frame for comparison with a corresponding row sum vector and column sum vector of another image frame.

### DETAILED DESCRIPTION

Aspects of the present disclosure may allow a device to detect in real-time camera tampering based on images or video captured by the camera. In some implementations, a device (such as a security system, a video camera, a video observation system, and so on) may determine a sum vector of intensity values from a first image frame, determine a second sum vector of intensity values from a second image frame captured after the first image frame, compare the first sum vector to the second sum vector, and detect camera tampering based on the comparison. In this manner, aspects of the present disclosure may allow a device to detect camera tampering without using additional sensors (such as motion sensors, light sensors, and so on).

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable electronic device (such as a security system with one or more cameras, smartphones, tablets, laptop computers, digital video and/or still cameras, web cameras, automobiles with one or more cameras, and so on). While described below with respect to a device having or coupled to one camera, aspects of the present disclosure are applicable to any number of cameras, and are therefore not limited to one camera. Additionally, aspects of the present disclosure are applicable for captured video as well as still images, and may be implemented in devices having or coupled to cameras of different capabilities (such as a video camera or a still image camera).

The term “device” is not limited to one or a specific number of physical objects (such as one smartphone, one camera controller, one processing system and so on). As used herein, a device may be any electronic device with one or more parts that may implement at least some portions of this disclosure. In one example, a device may be a video security system including one or more hubs and one or more separate cameras. In another example, a device may be a smartphone including a camera fixed to capture an intended scene. While the below description and examples use the term “device” to describe various aspects of this disclosure, the term “device” is not limited to a specific configuration, type, or number of objects.

Security or observation cameras may be used to record or observe a scene (such as a security camera for a store, a camera for a national park observation point, and so on). A camera may be tampered with so that the camera no longer captures the intended scene. In one example, a person may move the camera, cover the camera, change the focal point of the camera lens, shine a bright light or laser at the camera lens, or otherwise tamper with the camera. In another example, a storm, high winds, birds or other animals may move a camera, blur the scene being captured by the camera, or obstruct the camera's view.

Some cameras may include a motion sensor (such as a gyroscope or accelerometer), a light sensor, or other type of sensor to detect changes to the camera (such as movement or view obstruction). Adding sensors to a camera increases its manufacturing and setup cost, and many existing cameras do not include such sensors. Alternatively, post-processing operations of camera images or video may be used for detecting changes to the camera, for example, by storing the captured images or video in memory and then analyzing the stored images or video to detect camera tampering. However, such post-processing operations may undesirably delay the ability to detect changes to the camera, and analyzing stored image or video files may require significant processing resources. Aspects of the present disclosure are for detecting camera tampering. The detection does not require additional sensors and does not require fully processing and storing a video or image stream before attempting to detect tampering of the camera.

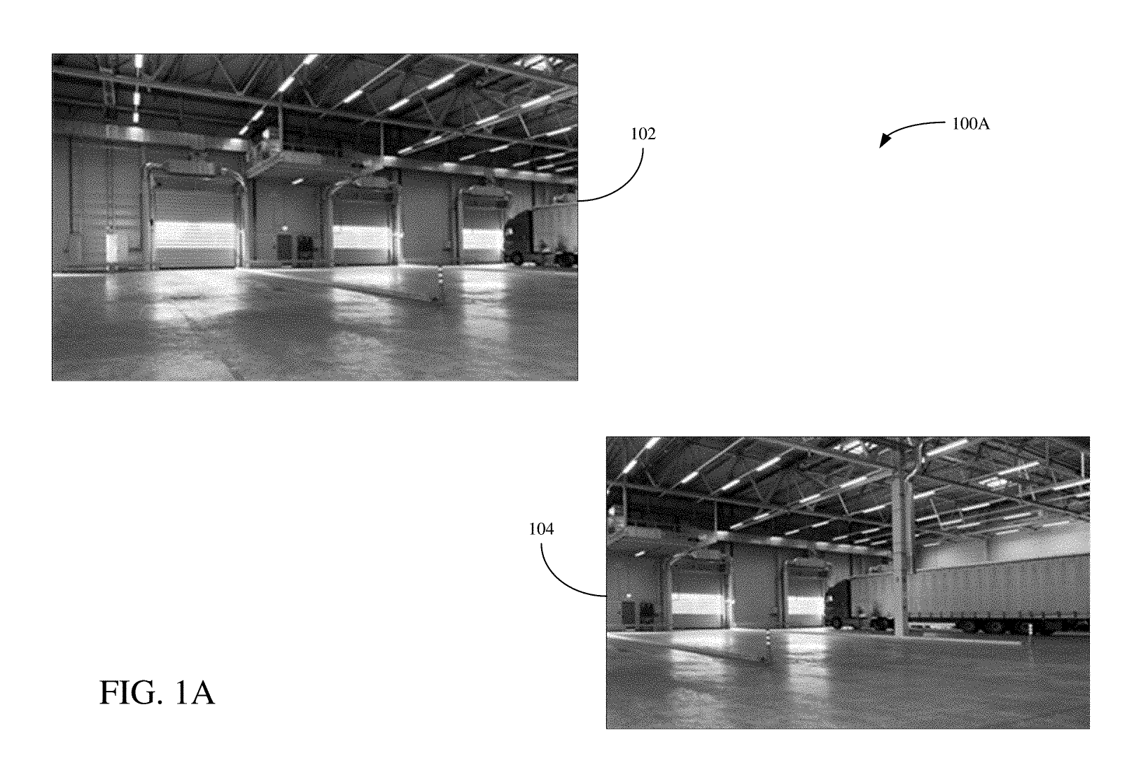

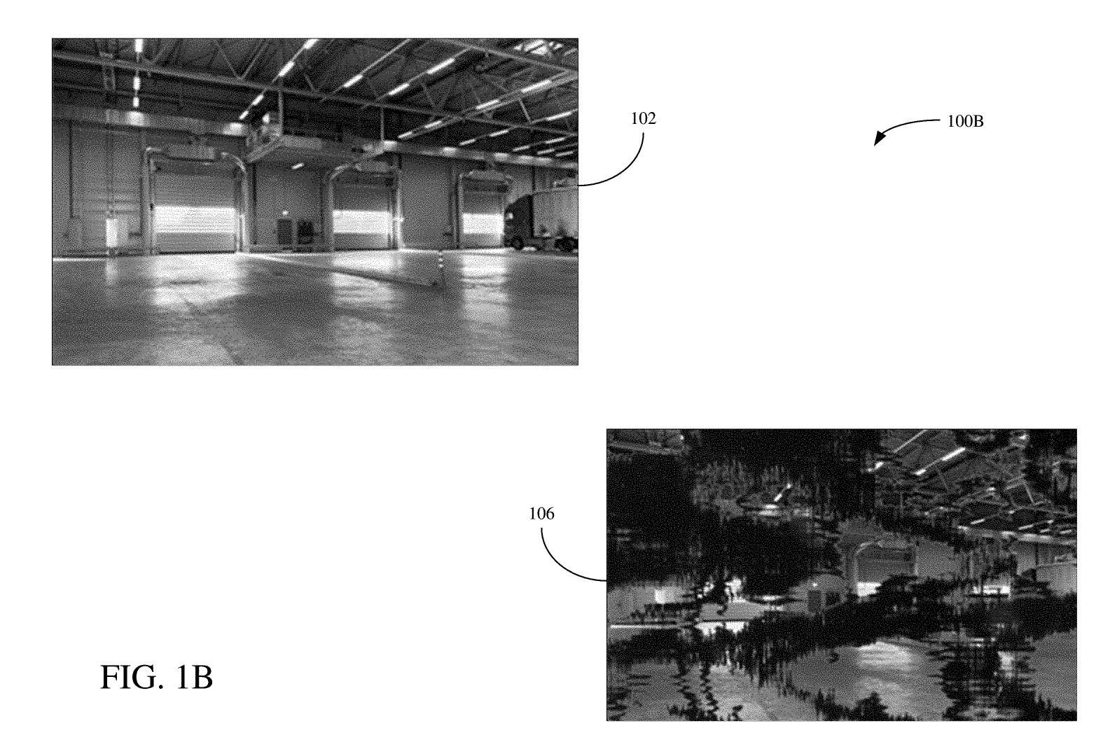

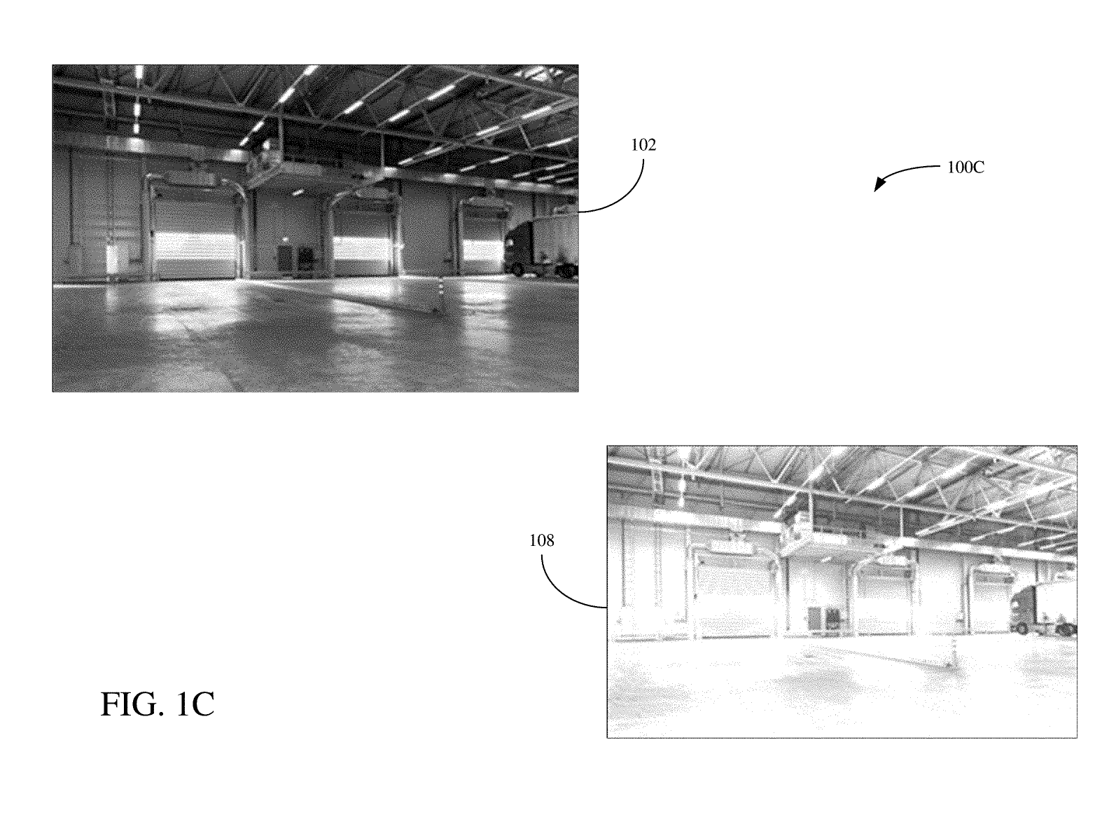

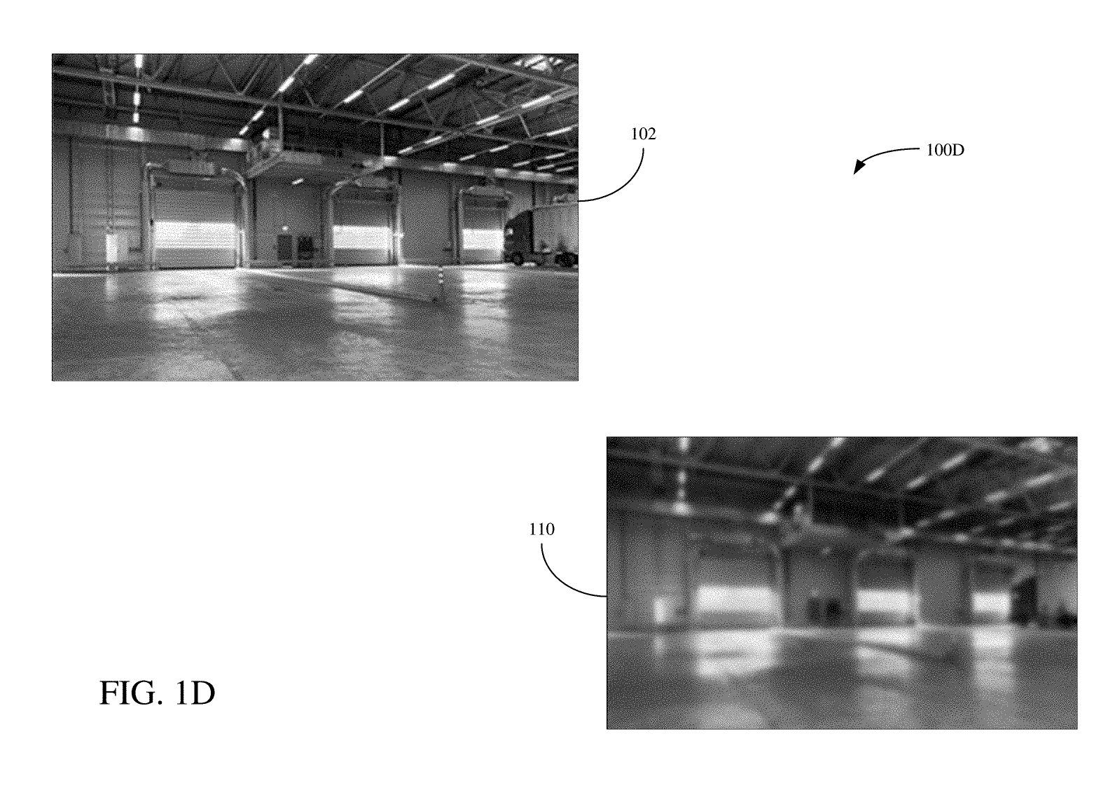

FIGS. 1A-1D depict examples of camera tampering. The examples are for illustrative purposes, and aspects of the disclosure should not be limited to the following examples. FIG. 1A is an illustration 100A depicting example camera movement. In the example, a camera may be positioned for observing a warehouse (such as for security purposes or to detect when trucks are coming or going). The camera may capture an example first image frame 102 that includes the intended scene of the three bay doors of a warehouse. The camera may later capture an example second image frame 104 indicating that the camera has been moved to the right or clockwise, for example, so that the left bay door visible in the first image frame 102 is not visible in the second image frame 102 (and is thus no longer in the field of view of the camera).

FIG. 1B is an illustration 100B depicting example camera obstruction. The camera may be covered by a cloth, paint or other obstruction of the camera lens that prevents the camera from capturing the scene. Image frame 106 depicts an example where paint covers portions of the camera's lens and obstructs the camera's view.

FIG. 1C is an illustration 100C depicting example light obstruction of a camera. A person may shine a bright light or laser at a camera sensor to wash out the captured image and thus prevent the camera from capturing the intended scene. Image frame 108 depicts an example of a light affecting the white balance setting of the camera to prevent the camera from capturing the scene.

FIG. 1D is an illustration 100D depicting example blurring of a camera image. A camera may be placed out of focus by a person changing the focal length of the camera lens. Images captured by the camera may also be blurred by having a film on the camera lens (such as ice, water, petroleum products, cleaning products, and so on).

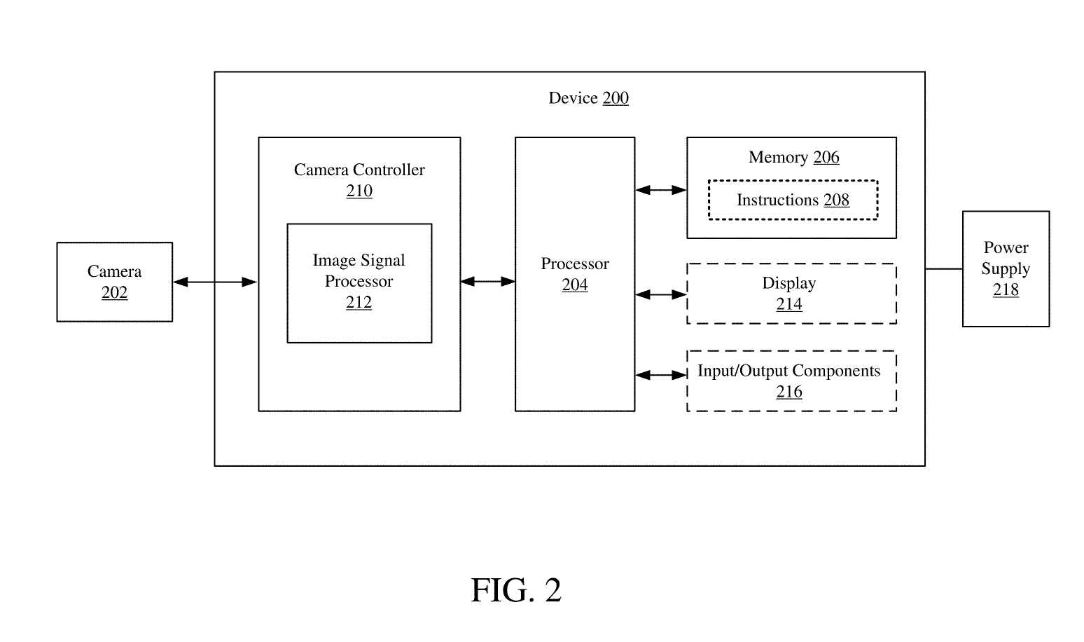

FIG. 2 is a block diagram of an example device 200 for detecting camera tampering. The example device 200, may include or be coupled to a camera 202, and may further include a processor 204, a memory 206 storing instructions 208, and a camera controller 210. The device 200 may optionally include (or be coupled to) a display 214 and a number of input/output (I/O) components 216. The device 200 may include additional features or components not shown. For example, a wireless interface, which may include a number of transceivers and a baseband processor, may be included for a wireless communication device. The device 200 may include or be coupled to additional cameras other than the camera 202. The disclosure should not be limited to any specific examples or illustrations, including the example device 200.

The camera 202 may be capable of capturing individual image frames (such as still images) and/or capturing video (such as a succession of captured image frames). The memory 206 may be a non-transient or non-transitory computer readable medium storing computer-executable instructions 208 to perform all or a portion of one or more operations described in this disclosure. The device 200 may also include a power supply 218, which may be coupled to or integrated into the device 200.

The processor 204 may be one or more suitable processors capable of executing scripts or instructions of one or more software programs (such as instructions 208) stored within the memory 206. In some aspects, the processor 204 may be one or more general purpose processors that execute instructions 208 to cause the device 200 to perform any number of functions or operations. In additional or alternative aspects, the processor 204 may include integrated circuits or other hardware to perform functions or operations without the use of software. While shown to be coupled to each other via the processor 204 in the example of FIG. 2, the processor 204, the memory 206, the camera controller 210, the optional display 214, and the optional I/O components 216 may be coupled to one another in various arrangements. For example, the processor 204, the memory 206, the camera controller 210, the optional display 214, and/or the optional I/O components 216 may be coupled to each other via one or more local buses (not shown for simplicity).

The display 214 may be any suitable display or screen allowing for user interaction and/or to present items (such as captured images and video) for viewing by a user. In some aspects, the display 214 may be a touch-sensitive display. The I/O components 216 may be or include any suitable mechanism, interface, or device to receive input (such as commands) from the user and to provide output to the user. For example, the I/O components 216 may include (but are not limited to) a graphical user interface, keyboard, mouse, microphone and speakers, and so on. The display 214 and/or the I/O components 216 may provide a notification to a user (such as a text alert, screen flash, beep, other audible notification, haptic feedback, and so on) if the device 200 detects tampering with the camera 202.

The camera controller 210 may include an image signal processor 212, which may be one or more image signal processors to process captured image frames or video provided by the camera 202. In some example implementations, the camera controller 210 (such as the image signal processor 212) may also control operation of the camera 202. In some aspects, the image signal processor 212 may execute instructions from a memory (such as instructions 208 from the memory 206 or instructions stored in a separate memory coupled to the image signal processor 212) to process image frames or video captured by the camera 202. In other aspects, the image signal processor 212 may include specific hardware to process image frames or video captured by the camera 202. The image signal processor 212 may alternatively or additionally include a combination of specific hardware and the ability to execute software instructions.

For a captured image frame, each image pixel is associated with an intensity or luminance. For example, a luminance of an image pixel may exist in a range of luminances (such as between 0 and 255, or some other suitable range), and may indicate the amount of light received by the camera sensor for the specific pixel. While other measurements of intensity may exist (such as luma, chrominance, saturation, and so on), the examples described herein illustrate luminance or brightness. The examples are for illustrative purposes, and intensity should not be limited to the provided examples.

The camera controller 210 may generate one or more sum vectors for an image being processed or to be processed. A sum vector is a vector of the intensity values summed for groups of pixels in an image. In some example implementations, the camera controller 210 (such as the image signal processor 212) may generate a column sum vector for which the intensities of pixels along a column of the image are summed and/or may generate a row sum vector for which the intensities of pixels along a row of the image are summed While the following examples of sum vectors are row sum vectors and column sum vectors, any grouping of pixels may be used for generating sum vectors. For example, sum vectors may be generated for pixels along a diagonal line, for pixels along an arc, for pixels along a broken line, or for pixels in a two-dimensional portion of the image. Accordingly, sum vectors should not be limited by the provided examples.

In one example of determining a column sum vector and a row sum vector of intensity of an image frame, the image may include 640×480 pixels with each pixel associated with a luminance value ranging from 0 (indicating black/no light) to 255 (indicating white/extremely bright). Determining an example column sum vector for an image frame may be expressed by equation (1) below:

I_{column sum}=[Σ_{q}i(1, q), Σ_{q}i(2, q), . . . , Σ_{q}i(640, q)] (1)

where q is within [1, 480] and i(r, q) is a luminance value (within [0, 255]) of the pixel located at column r and row q, where r is within [1, 640]. Determining an example row sum vector for the image frame may be expressed by equation (2) below:

I_{row sum}=[Σᵣi(r, 1), Σᵣi(r, 2), . . . , Σᵣi(r, 480)] (2)

where r is within [1, 640] and i(r, q) is a luminance value (within [0, 255]) of the pixel located at column r and row q, where q is within [1, 480]. In some other implementations, the measurement and range of intensity may be any suitable value or range, the image frame may be of any suitable size or resolution, and the image may be partitioned into more than one column or row for the column sum vector or row sum vector (so that multiple columns or multiple rows may be used in determining a value of the sum vector).

For some auto-exposure (AE) processes, device 200 may measure the average luminance of the captured image frame. Device 200 may then use the measurement to adjust an exposure time and/or a sensitivity of the sensor of camera 202. Setting changes to camera 202 (such as changing the exposure time or the sensor sensitivity) causes the intensity of subsequent captured images to change. For example, if the exposure time is increased, the average intensity of subsequent captured images increases. Accordingly, device 200 may prevent detecting camera tampering as a result of adjusting or during adjustment of one or more settings of camera 202.

Normalization of the sum vectors before comparison may reduce the number of camera tampering false detections by device 200. In some example implementations, device 200 (such as camera controller 210) may normalize a sum vector using one or more exposure parameters or measurements. For example, device 200 may use the average luminance value of the captured image frame to normalize a row sum vector and/or a column sum vector. If the sum vectors for comparison are normalized using an exposure parameter for the corresponding captured image frame, changes in intensity as a result of the AE process may be reduced or removed. In this manner, a sum vector of an image frame captured before the AE process may still be compared to a sum vector of an image frame captured after the AE process.

The camera controller 210 (such as the image signal processor 212) may provide the one or more sum vectors to the processor 204 before processing the captured image or while processing the captured image. The processor 204 or the camera controller 210 (such as a separate core of the image signal processor 212 or a separate image signal processor) may use the one or more sum vectors to detect tampering of the camera 202. In some example implementations, the device 200 may store sum vectors (such as in the memory 206 or in a memory coupled to the camera controller 210) from one or more image frames previously captured by the camera 202 (such as at a first time t1). The device 200 may compare the previously stored sum vectors to sum vectors for one or more image frames recently captured by the camera 202 (such as at a second time t2 that occurs after the first time t1). The device 200 may use the comparison to detect camera tampering that occurred after the previous images were captured by the camera 202 (such as during a time period between the first time t1 and the second time t2).

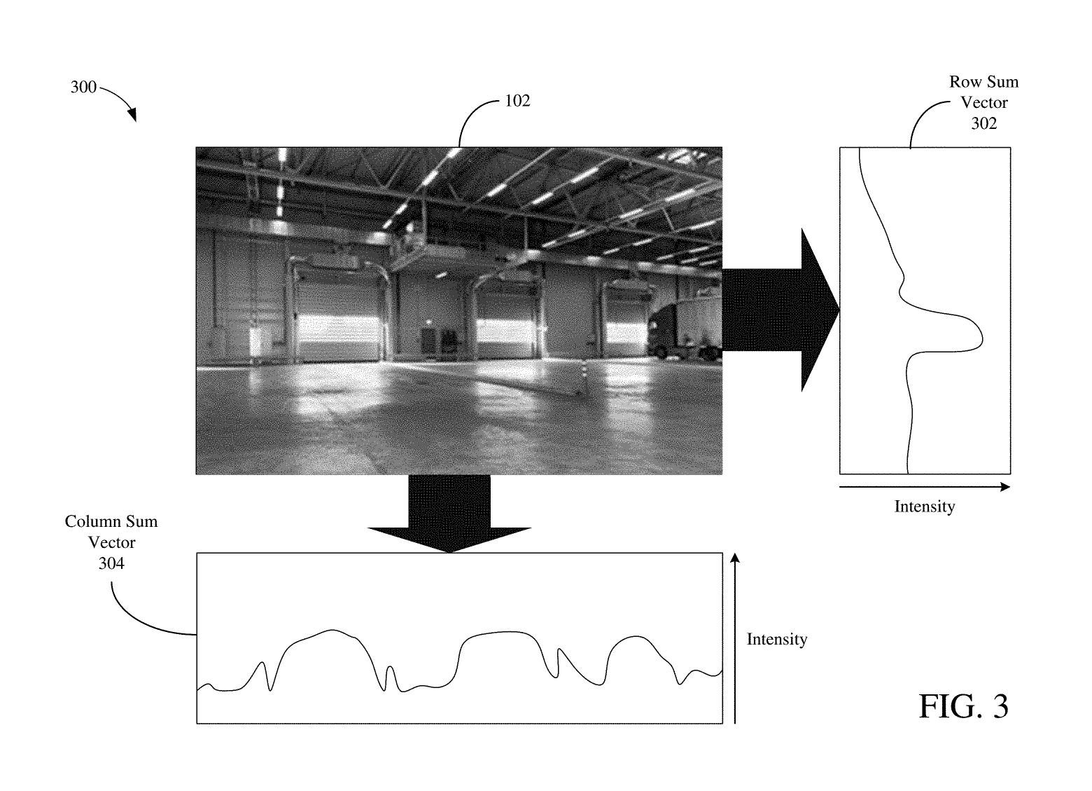

FIG. 3 is an illustration 300 depicting an example row sum vector 302 and an example column sum vector 304 of the camera image 102 in FIGS. 1A-1D. As shown, the light from the bay windows may cause an increased intensity value for corresponding positions of the row sum vector 302 and the column sum vector 304. The figures depict sum vectors graphically as curves, but the sum vectors may be an array or vector of values or numbers. The examples and illustrations are for conveying some aspects of the present disclosure, and aspects of the disclosure should not be limited by the examples. If the camera's position is fixed and the scene is static, the row sum vector 302 and the column sum vector 304 may be approximately constant across multiple image frames (with gradual changes possibly occurring as a result of changes in time of day or local movement of objects in the camera's field of view). If the camera is tampered with, a sum vector for an image captured after camera tampering may not be similar to a sum vector before camera tampering.

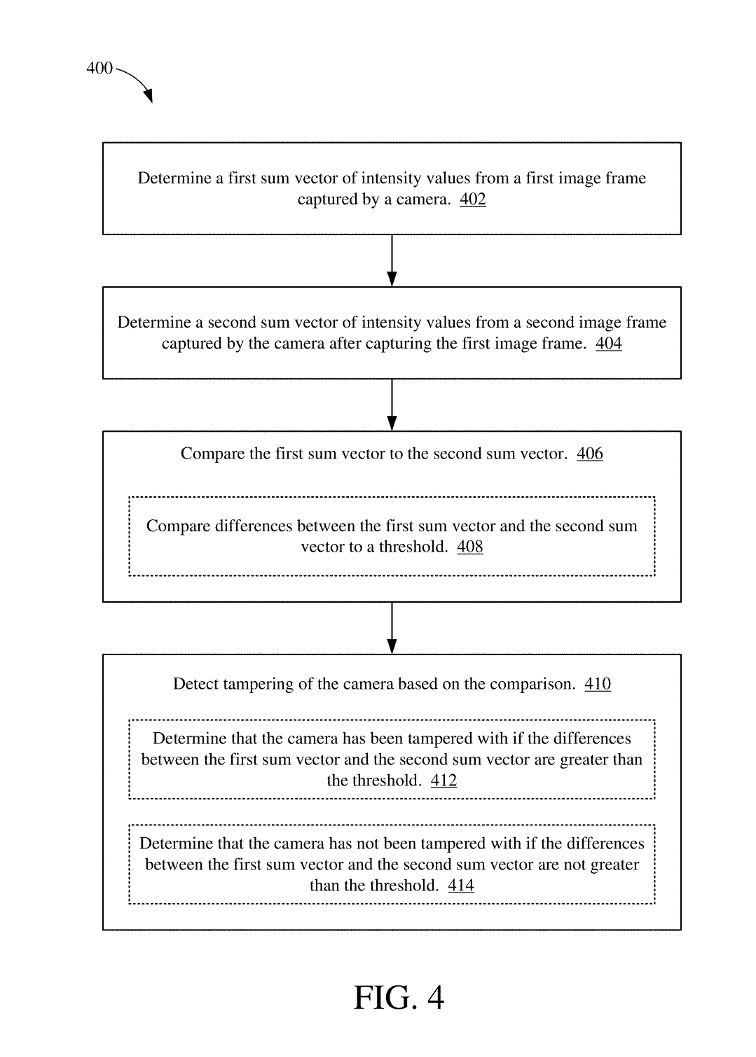

FIG. 4 is an illustrative flow chart depicting an example operation 400 for detecting camera tampering. Beginning at 402, the device 200 may determine from a first image frame a first sum vector of intensity values. The first image frame may be captured by the camera 202 before the camera 202 is tampered with. In some example implementations, the camera controller 210 (such as the image signal processor 212) may generate the first sum vector from the first image frame received from the camera 202.

The device 200 may then determine from a second image frame a second sum vector of intensity values (404). The camera 202 may capture the first image frame at a first time t1, and may capture the second image frame at a second time t2 that occurs after the first time t1. In some aspects, the second image frame may be the next image frame captured after the first image frame. In other aspects, a number of other image frames may be captured between the first image frame (at the first time t1) and the second image frame (at the second time t2). In some example implementations, the second sum vector may be generated in the same manner as the first sum vector, and/or the size of the second sum vector may be the same as the size of the first sum vector. In other example implementations, the second sum vector may be generated in a different manner than the first sum vector, and/or the size of the second sum vector may be different than the size of the first sum vector.

The device 200 then compares the first sum vector to the second sum vector (406). In some aspects, the camera controller 210 may determine if differences exist between the first sum vector and the second sum vector by comparing the corresponding intensity values for at least a portion of the first sum vector and the second sum vector. If there is local motion in the second image frame relative to the first image frame (such as a person or object moving in the scene) and no camera tampering, there may be small differences between the first sum vector and the second sum vector. For example, if a person walks across the warehouse in image frame 102, a small portion of the scene changes, thereby causing changes in a portion of the sum vector between captured image frames while the person is in the field of view of the camera 202. If the camera 202 is tampered with, the differences between the first sum vector and the second sum vector may be greater than the sum vector differences resulting from local motion (such as a greater change in intensity for at least a portion of the sum vector may be caused by camera tampering than by a person walking through the scene). In some example implementations, the device 200 may compare the differences between the first sum vector and the second sum vector to a threshold (408).

In some aspects, the threshold may be a size or portion of the second sum vector whose values are different than a corresponding size or portion of the first sum vector. In other aspects, the threshold may be an overall magnitude of difference in intensity between the first sum vector and the second sum vector. In some other aspects, the threshold may be one or more thresholds, and different types of thresholds may be used for comparing the first sum vector to the second sum vector.

After comparing the first sum vector to the second sum vector (406), the device 200 may detect camera tampering based on the comparison (410). For example, the device 200 may determine that the camera has been tampered with if the differences between the first sum vector and the second sum vector are greater than the threshold (412), and/or may determine that the camera has not been tampered with if the differences between the first sum vector and the second sum vector are not greater than the threshold (414).

In some aspects, the device 200 may detect camera tampering by determining whether the number of values in the second sum vector which are different than corresponding values in the first sum vector is greater than a threshold number. If the number of values in the second sum vector which are different than corresponding values in the first sum vector is greater than the threshold number, the device 200 may determine that the camera 202 has been tampered with. Conversely, if the number of values in the second sum vector which are different than corresponding values in the first sum vector is not greater than the threshold number, the device 200 may determine that the camera 202 has not been tampered with.

In other aspects, the device 200 may detect camera tampering by determining, for corresponding positions of the first sum vector and the second sum vector, if the difference between the first sum vector value and the second sum vector value is greater than a threshold. If the difference is greater than the threshold, the device 200 may determine that the camera 202 has been tampered with. Conversely, if the difference is not greater than the threshold, the device 200 may determine that the camera 202 has not been tampered with, for example, and that differences between image frames result from slight changes in environmental conditions.

In some other aspects, the device 200 may detect camera tampering by determining whether the magnitude of differences between the first sum vector and the second sum vector is greater than a threshold. If the magnitude of differences is greater than the threshold, the device 200 may determine that the camera 202 has been tampered with. Conversely, if the magnitude of differences is not greater than the threshold, the device 200 may determine that the camera 202 has not been tampered with, for example, and that the differences between image frames result from local motion. Other types of comparisons between the first sum vector and the second sum vector may be performed, and comparing the sum vectors should not be limited to the above examples.

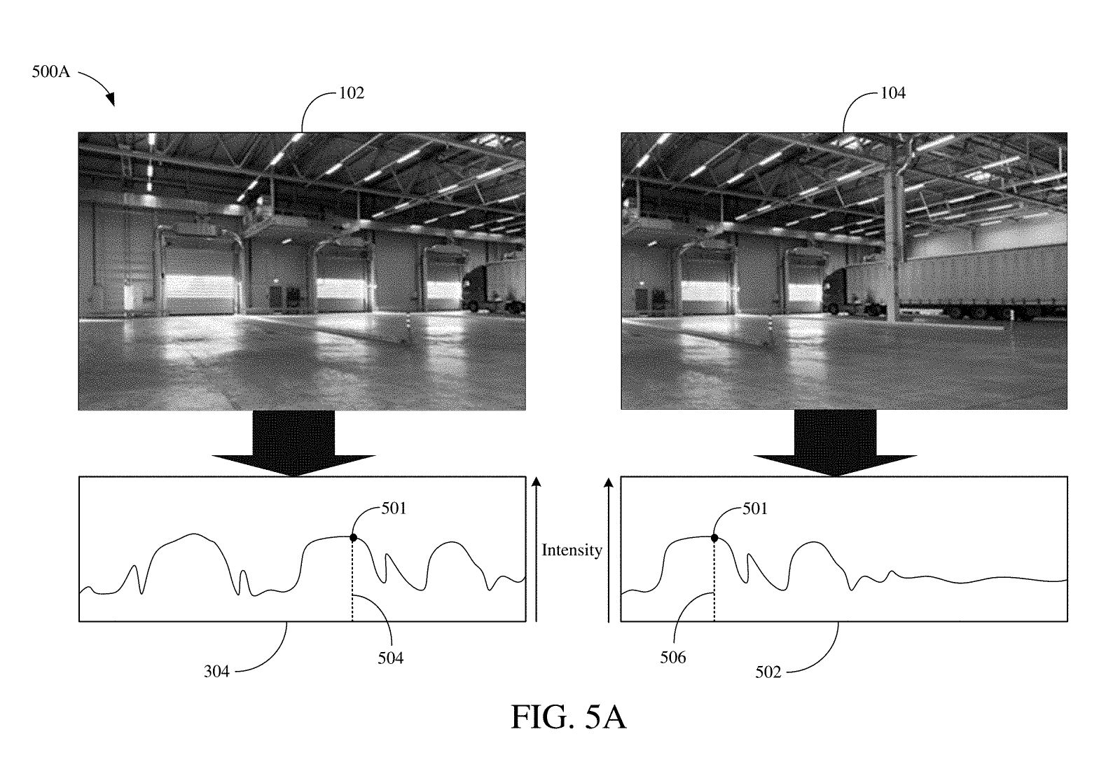

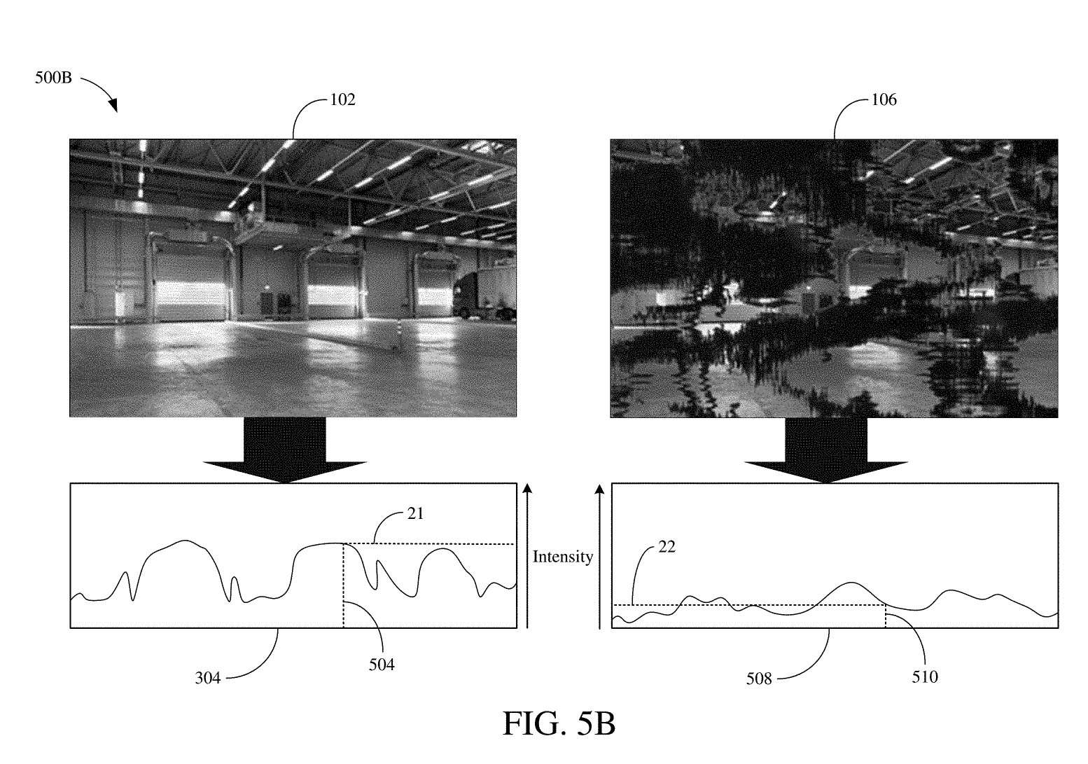

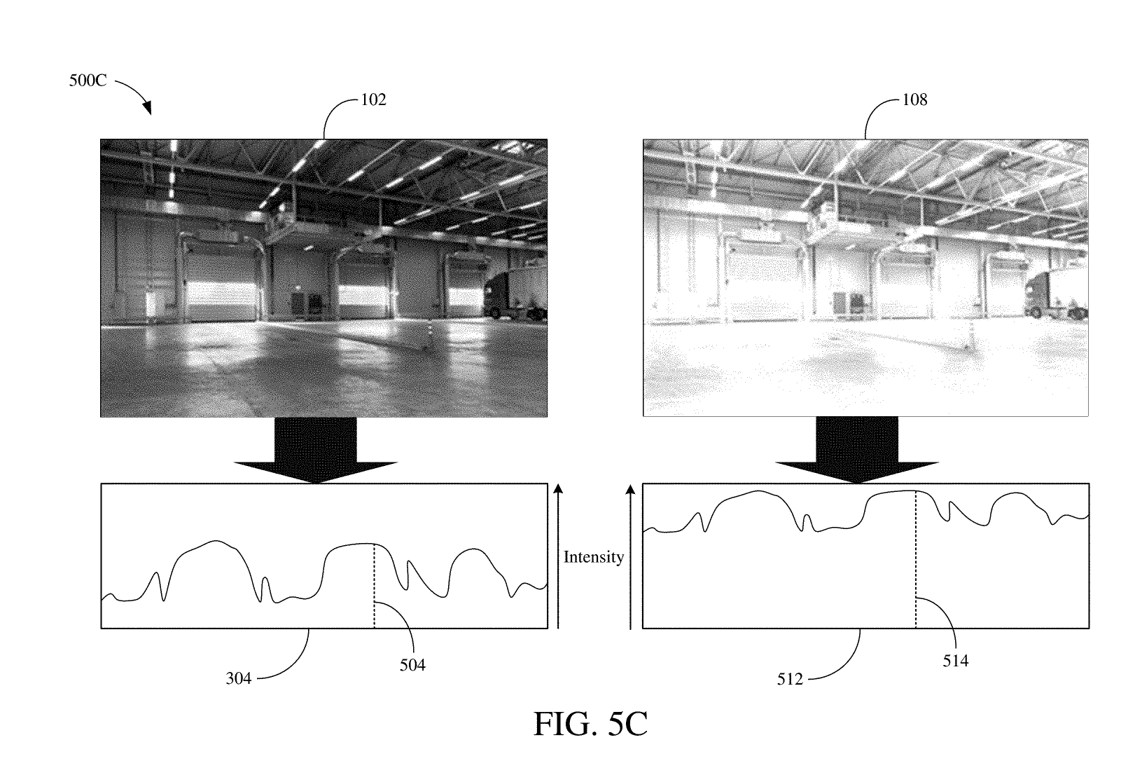

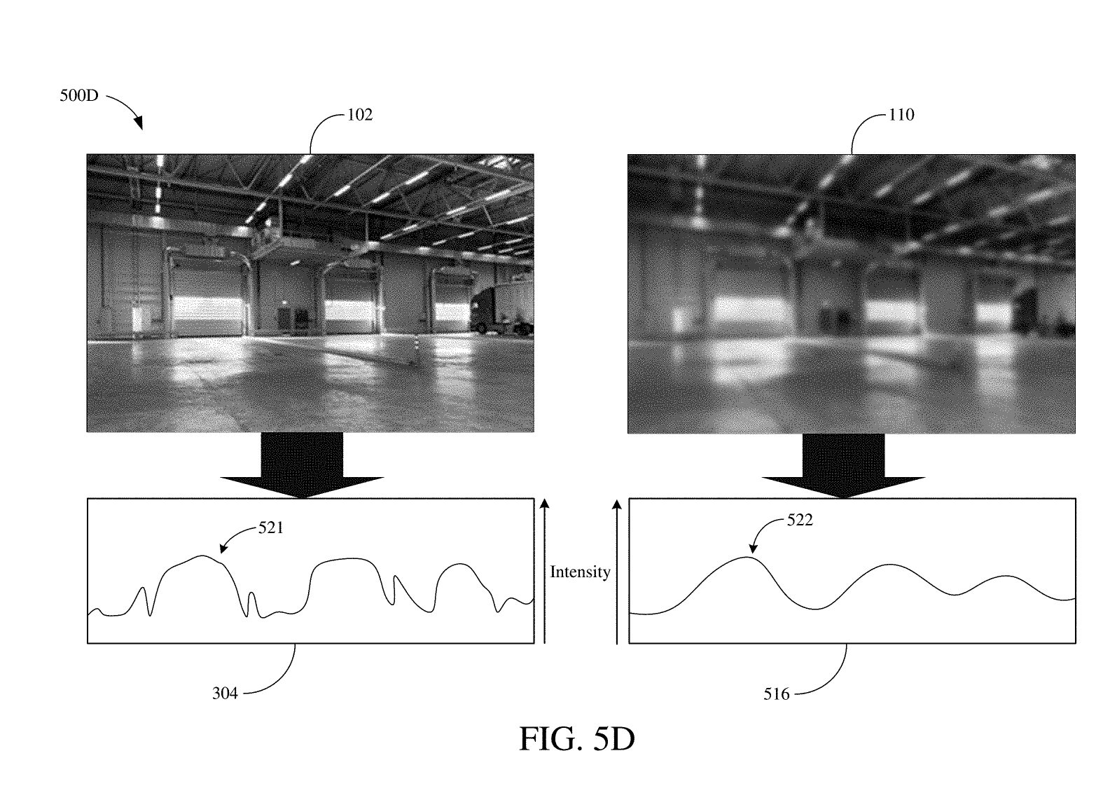

FIG. 5A is an illustration 500A depicting an example change in a column sum vector as a result of camera movement. Image frame 102 is without obstruction or tampering. Image frame 104 depicts movement of the camera 202 clockwise or to the right, for example, as described above with respect to FIG. 1A. A column sum vector 304 corresponds to the image frame 102 (before the camera is moved), and a column sum vector 502 corresponds to the image frame 104 (after the camera is moved). Movement of the camera may cause a shift of the graph for the column sum vector 304 to a new position for the column sum vector 502. As shown in the illustration 500A, movement of the camera causes a given point 501 of the graph for column sum vector 304 to move from a first position 504 to a second position 506 in column sum vector 502. Vertical movement of the camera may also cause the magnitude of values to change between the column sum vectors 304 and 502. A row sum vector may show a shift in position of intensity values when the camera is moved up or down. In some example implementations, comparing a first sum vector to a second sum vector to detect camera tampering may include determining if the second sum vector is a shifted version of the first sum vector (such as detecting a shift or a size of the shift of the values between the sum vectors).

FIG. 5B is an illustration 500B depicting an example change in a column sum vector as a result of camera obstruction. Image frame 102 is without obstruction or tampering. Image frame 106 depicts paint on the camera lens obstructing the camera's view, for example, as described above with respect to FIG. 1B. A column sum vector 304 corresponds to image frame 102 (before the camera lens is covered with paint), and a column sum vector 508 corresponds to image frame 106 (after the camera lens is covered with paint). Covering the camera may cause pixel intensities in an image frame to decrease. As a result, the sum vector for image frame 106 (captured after camera tampering) may have lower intensity values than the sum vector for image frame 102 (captured before camera tampering). For example, covering the camera lens may cause the intensity value 21 at position 504 in column sum vector 304 to decrease to the intensity value 22 at corresponding position 510 in column sum vector 508.

If the lens is completely covered or blacked out, the intensity values of the sum vector may approach or be equal to 0. In some example implementations, comparing a first sum vector to a second sum vector to detect camera tampering may include determining if the intensity values of the second sum vector (after camera lens obstruction) is less than the intensity values of the first sum vector (before camera lens obstruction). For example, the device 200 may determine if an average intensity value, a median intensity value, and/or a sum of the intensity values of the second sum vector is less than the average intensity value, the median intensity value, and/or the sum of the intensity values, respectively, of the first sum vector. In some example implementations, the device 200 may detect camera tampering by determining that the difference in values (such as the averages, the median values, and/or the sums of values) is greater than a threshold (such as to account for sampling error or environmental conditions not related to camera tampering).

An object may be close to the camera and pass through the camera's field of view so as to temporarily obstruct the camera's view. For example, a cat, worker, or forklift may pass directly in front of the camera, temporarily blocking the camera's view. While the object obstructs the camera's view, the values of the sum vectors may be temporarily lowered (which may be similar to decreases in sum vector values resulting from covering the camera). In some example implementations, the device 200 may determine if the camera lens is obstructed for more than a time period. In this manner, the device 200 may determine if the obstruction is temporary (such as local movement through the scene) or if the obstruction is more permanent or longer lasting (such as covering the camera lens) than the time period. The time period may allow the object to pass through the scene without the device 200 falsely determining camera tampering. For example, in some implementations, the device 200 may include a timer that can be initialized to a value corresponding to the time period. When the device 200 first detects that the camera lens is blocked or covered, the device 200 may start the timer. If the device 200 continues to detect the camera lens being blocked or covered until the timer reaches zero (thereby indicating expiration of the time period), the device 200 determines that the obstruction is camera tampering (such as covering the camera lens) rather than temporary (such as an object moving through the scene).

FIG. 5C is an illustration 500C depicting an example change in a column sum vector as a result of light obstruction of a camera. Image frame 102 is without obstruction or tampering. Image frame 108 depicts light shining on the camera lens and obstructing the camera's view (washing out the image frame), for example, as described above with respect to FIG. 1C. A column sum vector 304 corresponds to image frame 102 (before camera tampering), and a column sum vector 512 corresponds to image frame 108 (after camera tampering). In contrast to covering the camera lens (which decreases intensity values of the sum vector), shining a light on the camera lens may cause an increase in pixel intensities, for example, so that the sum vector for image frame 108 (captured after camera tampering) has greater intensity values than the sum vector for the image frame 102 (captured before camera tampering). For example, shining a light on the camera lens may cause the intensity value at position 504 in column sum vector 304 to increase to the intensity value at corresponding position 514 in column sum vector 512.

In some example implementations, comparing a first sum vector to a second sum vector to detect camera tampering may include determining if the intensity values of the second sum vector (after shining a light on the camera lens) is greater than the intensity values of the first sum vector (before shining a light on the camera lens). For example, the device 200 may determine if an average intensity value, a median intensity value, and/or a sum of the intensity values of the second sum vector is greater than the average intensity value, the median intensity value, and/or the sum of the intensity values, respectively, of the first sum vector. In some example implementations, the device 200 may detect camera tampering by determining that the difference in values (such as averages, median values, and/or sums of values) is greater than a threshold (such as to account for sampling error or environmental conditions not related to camera tampering).

FIG. 5D is an illustration 500D depicting an example change in a column sum vector as a result of blurring (placing the scene out of focus). Image frame 102 is without obstruction or tampering. Image frame 110 depicts blurring (such as by covering the camera lens with a film or changing the focal length of the camera), for example, as described above with respect to FIG. 1D. A column sum vector 304 corresponds to image frame 102 (before camera tampering), and a column sum vector 516 corresponds to image frame 110 (after camera tampering). Placing the camera out of focus may decrease the volatility of the sum vector. For example, the rate of change between values of a sum vector may decrease when the image frame is blurry, for example, because light intensity changes more gradually for blurry image frames than for focused image frames. As shown in the illustration 500D, the graph 522 representing the column sum vector 516 for image frame 110 is smoother than the graph 521 representing the column sum vector 304 for image frame 102. In some example implementations, the device 200 may detect camera tampering by determining if the volatility of the second sum vector is less than the volatility of the first sum vector.

In some aspects, the device 200 may determine a volatility of a sum vector based on its standard deviation, and may provide a comparison of the volatilities of first and second sum vectors by comparing the standard deviations (e.g., the rates of changes) of the first and second sum vectors. In other aspects, the device 200 may determine a volatility of a sum vector by determining differences between a number of neighboring values in the sum vector, and may provide a comparison of the volatilities of first and second sum vectors by comparing corresponding differences in the first and second sum vectors. In some other aspects, the device 200 may determine a volatility of a sum vector based on the number of local maxima and minima or number of inflection points for a sum vector, and may provide a comparison of the volatilities of first and second sum vectors by comparing the number of maxima and minima or number of inflection points of the first sum vector with the number of maxima and minima or number of inflection points of the second sum vector.

In some example implementations for comparing a first sum vector and a second sum vector, the device 200 may compare one or more portions or segments of the first sum vector to corresponding portions or segments of the second sum vector. The device 200 may conserve computing resources and/or increase the speed with which camera tampering is detected by comparing portions of the first sum vector with portions of the second sum vector (rather than comparing the entire sum vectors with each other).

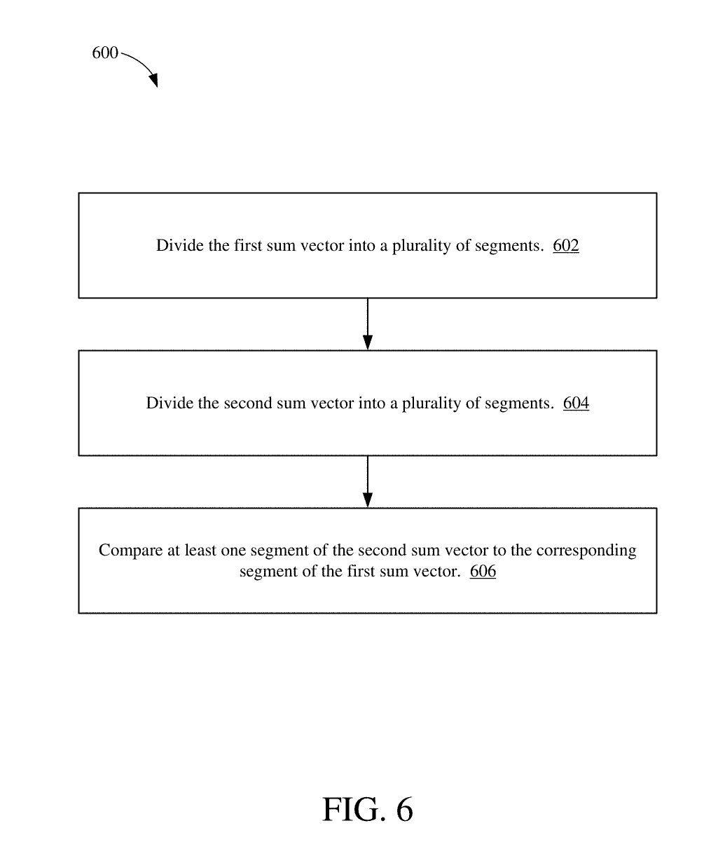

FIG. 6 is an illustrative flow chart depicting an example operation 600 for comparing one or more segments of a first sum vector to corresponding segments of a second sum vector. Beginning at 602, the device 200 may divide the first sum vector into a plurality of segments. The segments may be of any size. In some example implementations, the size of the segments is uniform. In other example implementations, the sizes of the segments may differ.

The device 200 may then divide the second sum vector into a plurality of segments (604). In some example implementations, each segment of the first sum vector corresponds to a respective segment of the second sum vector. Corresponding segments of the first and second sum vectors may be the same size and/or may correspond to the same location in the captured image frames. The device 200 may compare at least one segment of the second sum vector to the corresponding segment of the first sum vector (606). In this manner, the device 200 may detect camera tampering without comparing all of the segments of the first and second sum vectors.

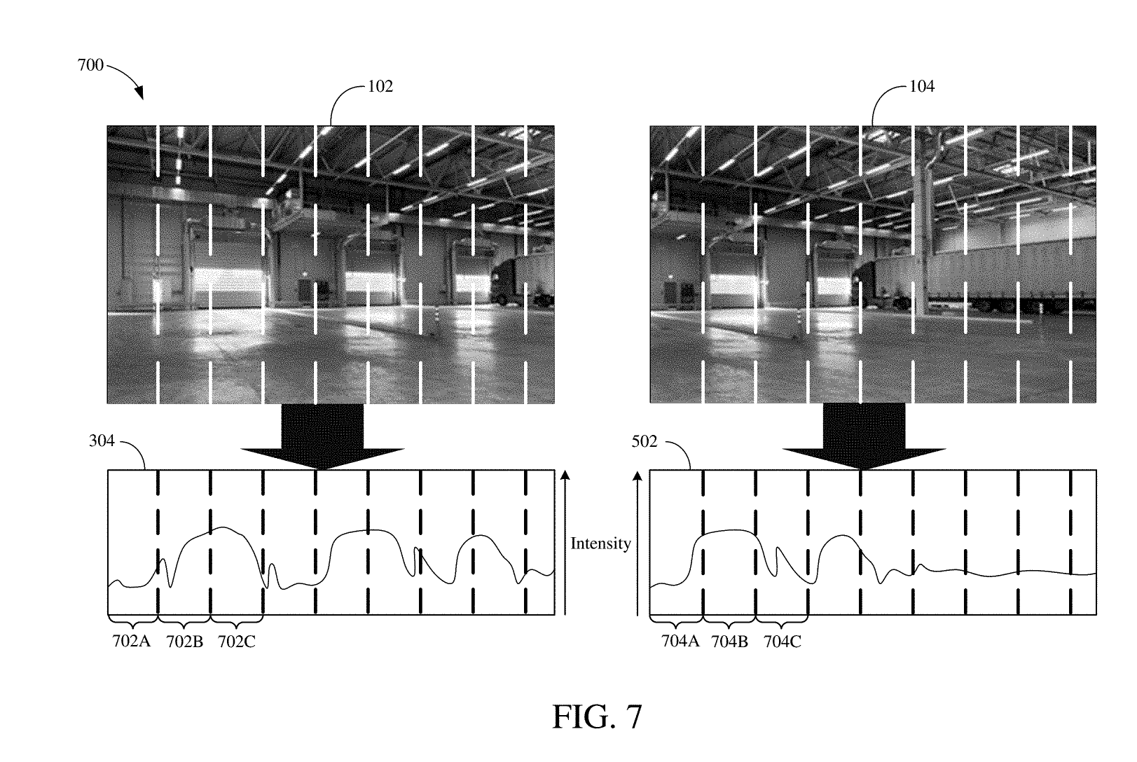

FIG. 7 is an illustration 700 depicting an example segmentation of a first column sum vector 304 for image frame 102 and a second column sum vector 502 for image frame 104. Column sum vector 304 is divided into a number of segments including, for example, segment 702A, segment 702B, and segment 702C. Each of the segments of the first column sum vector 304 corresponds to a number of columns of pixels of image frame 102. While contiguous segments of similar size are shown in the example illustration 700, the segments may be noncontiguous, overlapping, and/or of different sizes.

Column sum vector 502 is divided into a number of segments including, for example, segment 704A, segment 704B, and segment 704C. Each of the segments of the second column sum vector 502 corresponds to a number of columns of pixels of image frame 104. Corresponding segments of the first column sum vector 304 and the of the second column sum vector 502 are shown to correspond to approximately the same locations of image frame 102 and image frame 104, respectively, and are also shown to be of approximately the same size. In the illustration 700, segment 704A of the second column sum vector 502 corresponds to segment 702A of the first column sum vector 304, segment 704B of the second column sum vector 502 corresponds to segment 702B of the first column sum vector 304, and segment 704C of the second column sum vector 502 corresponds to segment 702C of the first column sum vector 304. When comparing the first column sum vector 304 and the second column sum vector 502, the device 200 may compare segment 702A to segment 704A, may compare segment 702B to segment 704B, and/or may compare segment 702C to segment 704C (such as by using any of the previously described comparison techniques).

In some example implementations, the device 200 may compare a subset of segments of the first and second sum vectors. In one example, the device 200 compares non-flat field segments of a first sum vector to corresponding segments of the second sum vector. In the example, flat field segments of the first sum vector may not be used in the comparison.

A flat field segment is a segment of the sum vector for which the values in the segment are similar to each other (such as the values being within a range less than a threshold). If the intensity across the segment is approximately uniform, the values in the segment of the sum vector may be similar to one another. For example, a segment of a sum vector corresponding to a portion of an image frame of a uniform color with no light differentiations (such as a bare wall, floor or ceiling) may have similar intensity values across the segment, and therefore the segment may be determined to be a flat field segment. In some example implementations, a non-flat field segment may be a segment of the sum vector for which the values in the segment are different from one another (such as the difference in values being greater than the threshold).

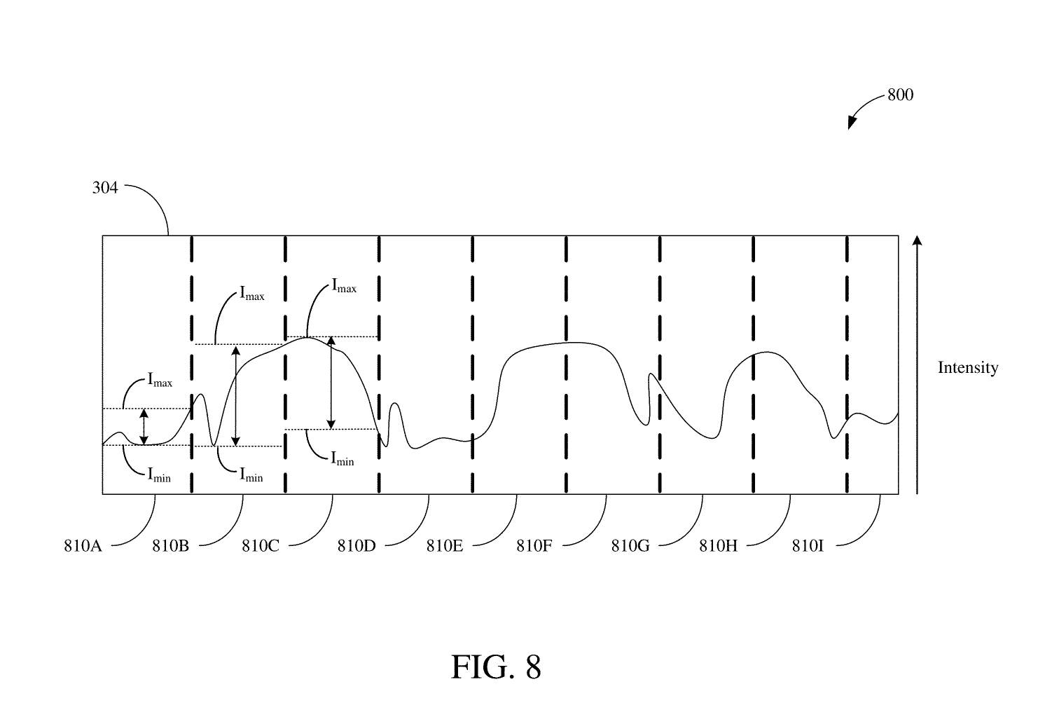

FIG. 8 is an illustration 800 depicting example differences in intensity values of a number of the segments 810A-810I of a sum vector 304. The differences in intensity values in one or more of the segments 810A-810I may be used to determine if the respective segment(s) is a flat field segment or a non-flat field segment. Each segment 810A-810I may include a largest value (Iₘₐₓ) and a smallest value (Iₘᵢₙ) for the segment. The range of values for each segment may be denoted as I_{diff} and may be expressed by Equation (3) below:

I_{diff}=Iₘₐₓ−Iₘᵢₙ (3)

For example, I_{diff} for segment 810A may be Iₘₐₓ−Iₘᵢₙ in segment 810A, I_{diff} for segment 810B may be Iₘₐₓ−Iₘᵢₙ in segment 810B, and I_{diff} for segment 810C may be Iₘₐₓ−Iₘᵢₙ in segment 810C.
I_{diff} may alternatively be determined by other means. For example, the device 200 may compare one or two standard deviations above the mean of intensity values for the respective segment and one or two standard deviations below the mean of intensity values for the respective segment to remove outlier values when determining I_{diff}. In another example, the device 200 may compare Iₘₐₓ and/or Iₘᵢₙ to the median intensity value or to the mean intensity value of the respective segment to determine I_{diff}. Other techniques for determining I_{diff} may be used, and aspects of the present disclosure should not be limited by the provided examples. Further, I_{diff} may be determined for a subset of segments of a sum vector, or I_{diff} may be determined for all segments of a sum vector. In this manner, device 200 may determine if a segment is flat field or non-flat field for all of the segments or for only a subset of the segments.

In some example implementations, the device 200 may compare I_{diff} to a threshold to determine if the segment is a flat field segment or a non-flat field segment. The device 200 may then use the non-flat field segments for comparing a first sum vector to a second sum vector to detect camera tampering. In using the non-flat field segments, the device 200 may use portions of the image frame with larger variations in light intensity (such as in image frame 102 where windows occur in the bay doors, the wall is non-uniform, and so on) than portions of the image frame with smaller variations in light intensity.

The device 200 may compare a measurement other than I_{diff} to a threshold to determine if the segment is a flat field segment or a non-flat field segment. For example, the device 200 may compare a determined variance or standard deviation for the segment to a threshold. Other measurements may also be used, and aspects of the present disclosure should not be limited to the provided examples.

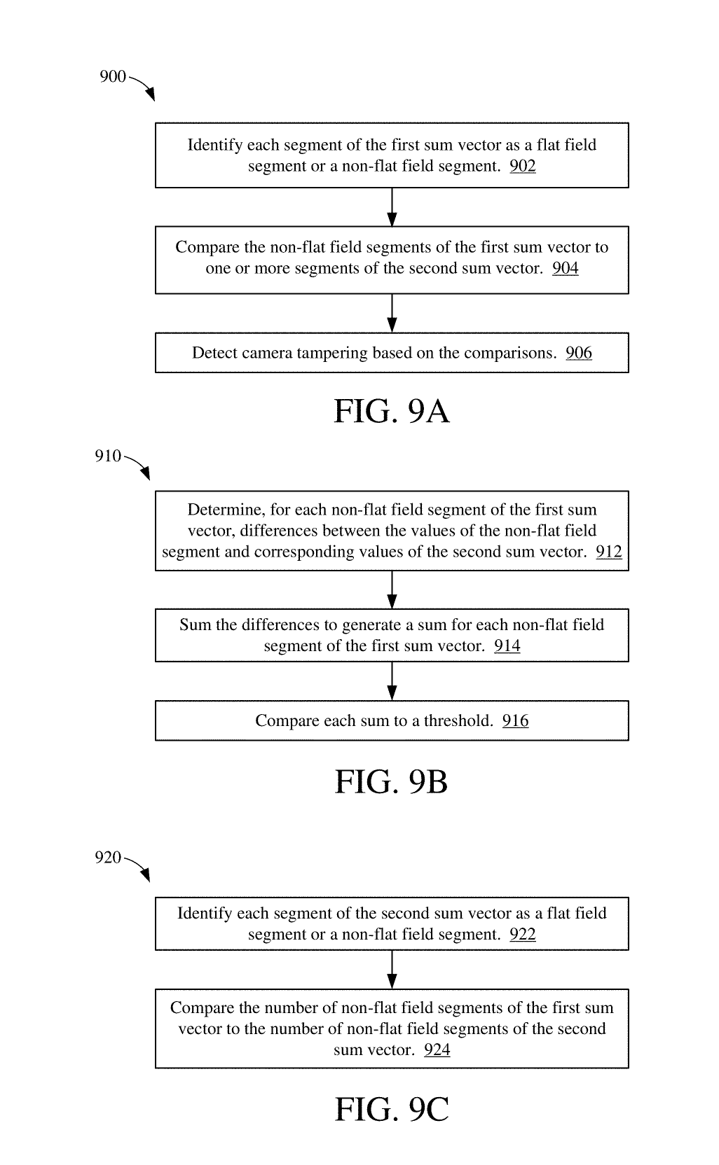

FIG. 9A is an illustrative flow chart depicting an example operation 900 for detecting camera tampering. In some example implementations, the example operation 900 may be performed by the device 200 to detect camera tampering based on a comparison of non-flat field segments of a first sum vector with segments of a second sum vector. Beginning at 902, the device 200 may identify each segment of the first sum vector as a flat field segment or a non-flat field segment. The device 200 may compare the non-flat field segments of the first sum vector to one or more segments of the second sum vector (904), and may detect camera tampering based on the comparisons (906).

In some example implementations, the device 200 may compare the non-flat field segments of the first sum vector to corresponding segments of the second sum vector. If the device 200 determines that the corresponding segments of the second sum vector are sufficiently different from the non-flat field segments of the first sum vector, the device 200 may detect camera tampering. Conversely, if the device 200 determines that the corresponding segments of the second sum vector are not sufficiently different from the non-flat field segments of the first sum vector, the device 200 may not detect camera tampering.

FIG. 9B is an illustrative flow chart depicting an example operation 910 for comparing non-flat field segments of the first sum vector with segments of the second sum vector. In some aspects, the device 200 may determine, for each non-flat field segment of the first sum vector, differences between the values of the non-flat field segment of the first sum vector and corresponding values of the second sum vector (912). The device 200 may sum the differences to generate a sum for each non-flat field segment of the first sum vector (914). The device 200 may compare each of the sums to a threshold (914) and, referring again to FIG. 9A, may detect camera tampering based on the comparison (906). For example, if the sums are greater than the threshold, the device 200 may detect camera tampering. Conversely, if the sums are not greater than the threshold, the device 200 may not detect camera tampering.

The threshold may be uniform across the segments. Alternatively, the threshold may be different for the different segments. In one example, segments corresponding to edges of the image frame may be first affected by covering a camera. In this manner, the threshold may be lower for those segments than a typical threshold or threshold used for other segments so that camera tampering may be detected more quickly than if using the typical threshold. In another example, segments corresponding to large amounts of local motion (such as a segment corresponding to a busy street or sidewalk in the scene) may have greater thresholds so that false detections of camera tampering resulting from local motion may be avoided.

The device 200 may determine some of the non-flat field segments of the first sum vector to be sufficiently different than corresponding segments of the second sum vector while other non-flat field segments of the first sum vector are determined not to be different than corresponding segments of the second sum vector. In some example implementations, the device 200 may determine if the number of segments of the first sum vector which are different from corresponding segments of the second sum vector is greater than a threshold. In one example, the device 200 may detect camera tampering if at least half (or a third, a quarter, and so on) of the segments of the first sum vector are different from corresponding segments of the second sum vector. In another example, the device 200 may detect camera tampering if all non-flat field segments of the first sum vector are determined to be different from corresponding segments in the second sum vector.

Referring again to the example operation 900 in FIG. 9A, in some other example implementations, the device 200 may compare the number of non-flat field segments of the first sum vector to the number of non-flat field segments of the second sum vector. If the number of non-flat field segments of the first sum vector is different than the number of non-flat field segments of the second sum vector, the device 200 may detect camera tampering.

FIG. 9C is an illustrative flow chart depicting an example operation 920 for comparing non-flat field segments of the first sum vector with non-flat field segments of the second sum vector. The device 200 may identify each segment of the second sum vector as a flat field segment or a non-flat field segment (922). The device may compare the number of non-flat field segments of the first sum vector to the number of non-flat field segments of the second sum vector (924) and, referring again to FIG. 9A, may detect camera tampering based on the comparison (906).

The number of non-flat field segments between sum vectors not as a result of camera tampering may slightly differ (such as the number of non-flat field segments for the first image frame may be one less or one more than the number of non-flat field segments for the second image frame). In some example implementations, the device 200 may determine if the difference in number of non-flat field segments for the sum vectors is greater than a threshold (such as greater than 1, 2, and so on) to detect camera tampering. Alternatively, the device 200 may detect camera tampering if there is any difference between the number of non-flat field segments in the first sum vector and the number of non-flat field segments in the second sum vector.

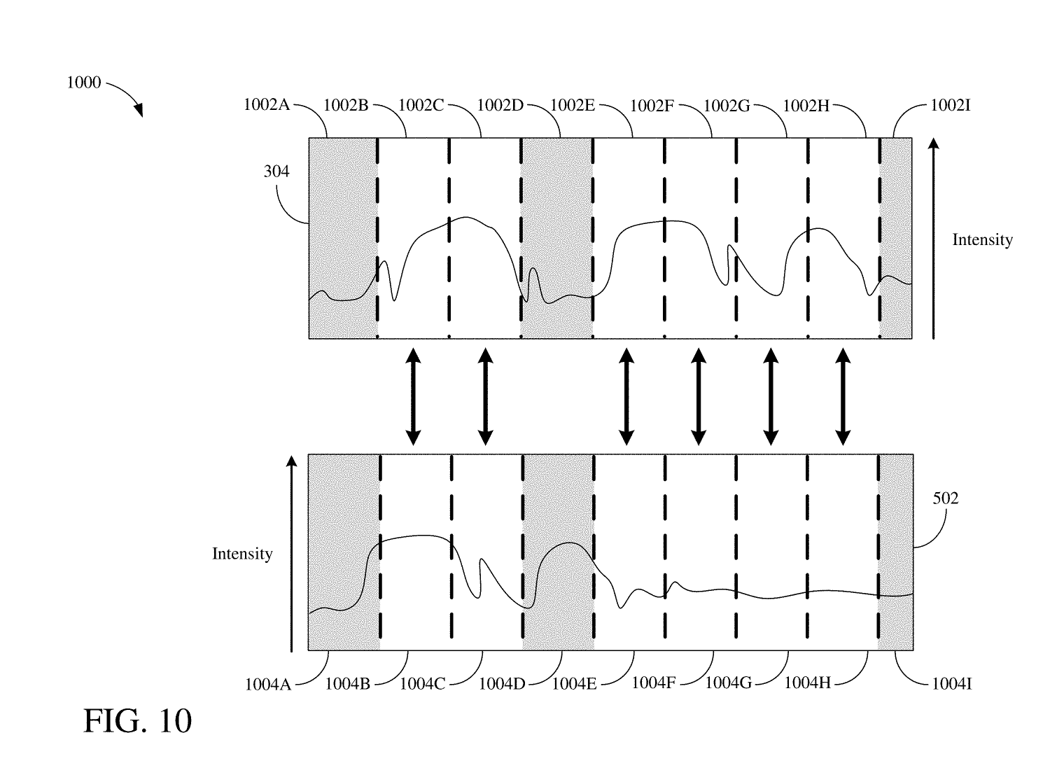

FIG. 10 is an illustration 1000 depicting example non-flat field segments of column sum vector 304 being compared to a corresponding segment of column sum vector 502. Column sum vector 304 is divided into segments 1002A-1002I, and column sum vector 502 is divided into corresponding segments 1004A-10041. The device 200 may determine that segments 1002A, 1002D and 1002I of column sum vector 304 are flat field segments, and may determine that segments 1002B, 1002C, 1002E, 1002F, 1002G, and 1002H of column sum vector 304 are non-flat field segments. In the example of FIG. 10, the device 200 may thus compare non-flat field segments 1002B, 1002C, 1002E, 1002F, 1002G, and 1002H of column sum vector 304 to corresponding segments 1004B, 1004C, 1004E, 1004F, 1004G, and 1004H, respectively, of column sum vector 502.

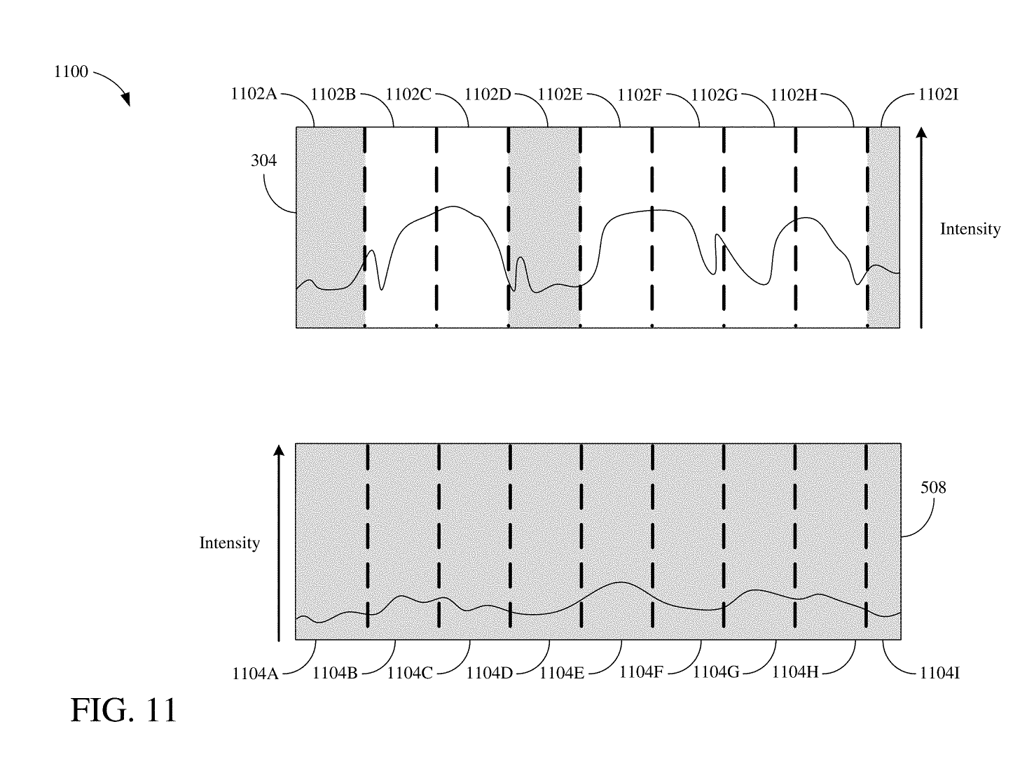

FIG. 11 is an illustration 1100 depicting example non-flat field segments of a column sum vector 304 and example non-flat field segments of a column sum vector 508. Column sum vector 304 is divided into segments 1102A-1102I, and column sum vector 508 is divided into corresponding segments 1104A-1104I. The device 200 may determine that segments 1102A, 1102D and 1102I of column sum vector 304 are flat field segments, and may determine that segments 1102B, 1102C, 1102E, 1102F, 1102G, and 1102H of column sum vector 304 are non-flat field segments. In the example of FIG. 11, the device 200 may determine that the number of non-flat field segments of column vector 304 is 6. The device 200 may also determine that all of the segments 1104A-1104I of column sum vector 508 are flat field segments and the number of non-flat field segments in column sum vector 508 is 0. The device 200 may thus compare the number of non-flat field segments of column sum vector 304 (6) to the number of non-flat field segments of column sum vector 508 (0) to detect camera tampering (such as covering the camera lens, pushing the camera to point to the floor, shining a light at the camera lens to wash out the captured image frames, and so on).

While the above examples describe comparing one sum vector of a first image frame to one sum vector of a second image frame, multiple sum vectors for a first image frame may be compared to multiple sum vectors for a second image frame. For example, the device 200 may compare corresponding column sum vectors between image frames and compare corresponding row sum vectors between image frames. In some example implementations, the device 200 may segment the plurality of sum vectors so that the device 200 may compare corresponding segments (such as performing previously described techniques in comparing segments).

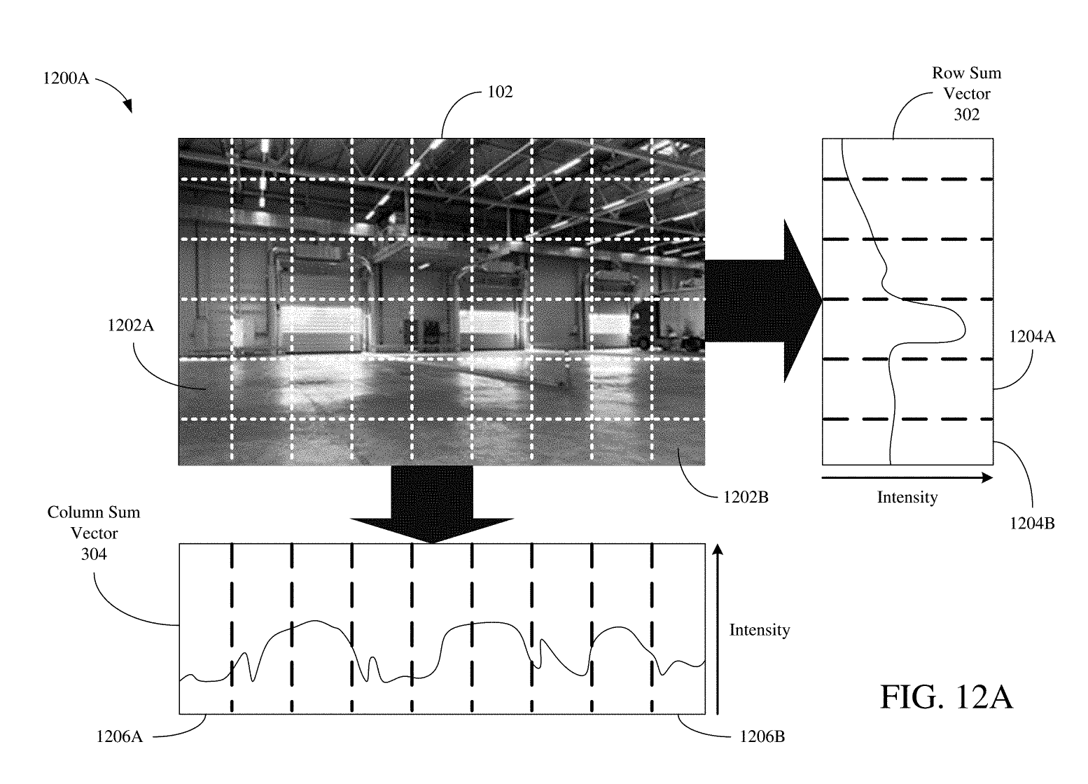

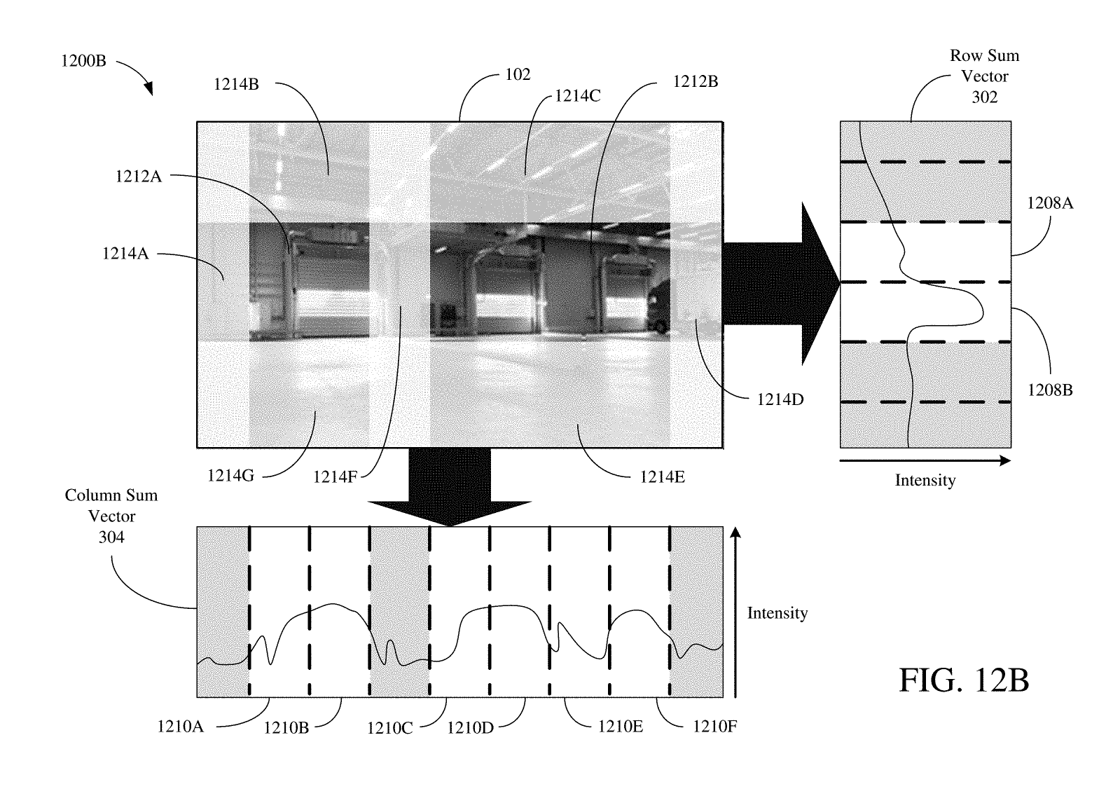

FIG. 12A is an illustration 1200A depicting an example segmentation of a row sum vector 302 and a column sum vector 304 of image frame 102. Dividing row sum vector 302 into M number of segments and dividing column sum vector 304 into N number of segments may divide image frame 102 into M×N portions, where each portion may correspond to a different pair of a row sum segment and a column sum segment. For example, a first portion 1202A of image frame 102 may correspond to row sum segment 1204A and column sum segment 1206A, and a second portion 1202B of image frame 102 may correspond to row sum segment 1204B and column sum segment 1206B.

The row sum vector 302 may be compared to a corresponding row sum vector of another image frame, and the column sum vector 304 may be compared to a corresponding column sum vector of the another image frame. If the device 200 does not use all of the segments of a sum vector during the comparison, not all of the portions of the image frame might influence the comparison. For example, if the device 200 only compares non-flat field segments of sum vectors, one or more of the portions of the image frame having a uniform or flat field of light intensity (such as portions of the floor) may not influence the comparison.

The device 200 may compare different sum vectors (such as column sum vectors and row sum vectors) in different ways. In one example, the device 200 compares a first type of sum vectors and then compares a second type of sum vectors. If camera tampering is detected by comparing the first type of sum vectors, the device 200 may skip comparing the second type of sum vectors. In another example, the device 200 compares the different types sum vectors concurrently.

FIG. 12B is an illustration depicting example non-flat field segments 1208A and 1208B of row sum vector 302 and example non-flat field segments 1210A-1210F of column sum vector 304 of image frame 102. In one example, the device 200 detects a difference for one or more non-flat field segments 1208A and 1208B of row sum vector 302 and detects a difference for one or more non-flat field segments 1210A-1210F of column sum vector 304 before detecting camera tampering. Portions 1212A and 1212B are the intersection between the portions of image frame 102 associated with non-flat field segments 1208A-1208B of row sum vector 302 and portions of image frame 102 associated with non-flat field segments 1210A-1210F of column sum vector 304. In the example, changes in portions 1212A-1212B of image frame 102 may influence whether camera tampering is detected by the comparison.

Portions 1212A-1212B and portions 1214A-1214G are the union between the portions of image frame 102 associated with non-flat field segments 1208A-1208B of row sum vector 302 and portions of image frame 102 associated with non-flat field segments 1210A-1210F of column sum vector 304. In another example, the device 200 detects a difference for one or more non-flat field segments 1208A-1208B of row sum vector 302 or detects a difference for one or more non-flat field segments 1210A-1210F of column sum vector 304 before detecting camera tampering. In the example of FIG. 12B, changes in portions 1212A and 1212B and portions 1214A-1214G of image frame 102 may influence whether camera tampering is detected by the comparison. In some example implementations, changes in portions 1212A-1212B may have more influence than changes in portions 1214A-1214G in detecting camera tampering since both the corresponding row sum segments and the corresponding column sum segments for portions 1212A-1212B are used in the comparison. The device 200 may perform other example comparisons for multiple types of sum vectors (such as using only a subset of each group of non-flat field segments), and aspects of the present disclosure should not be limited to the examples.

In some example implementations, the device 200 may be configured to compare sum vectors for more than two image frames. For example, if the device 200 compares corresponding segments of the sum vectors, the device 200 may determine that the difference between a segment of a first image frame and corresponding segments of successive image frames is always above a threshold when detecting tampering. Aspects of the present disclosure should not be limited to comparing two or other specific number of image frames.

Different types of thresholds are described in the examples. The thresholds may be fixed or adjustable, and the thresholds may be determined by a manufacturer, a user, a device, or a combination of the above. In one example, if too many false detections occur, a user may adjust or the device may automatically adjust the thresholds for comparing the sum vectors to attempt to reduce the occurrences of false detections. In another example, thresholds may depend on a type of scene. For example, thresholds for an indoor scene may be lower than thresholds for an outdoor scene where changes in lighting and movement of objects may be more frequent than for an indoor scene. In some example implementations, a user may select a scene type, and the device may set the one or more thresholds based on the user selection. As the threshold may be determined and used in a variety of ways, aspects of the present disclosure should not be limited to any specific type of threshold or threshold value as described in the examples.

The techniques described herein may be implemented in hardware, software, firmware, or any combination thereof, unless specifically described as being implemented in a specific manner For example, the described various processes and determinations may be implemented as specialty or integrated circuits in an image signal processor (such as the image signal processor 212), as software (such as the instructions 208) to be executed by the image signal processor 212 of the camera controller 210 or the processor 204, or as firmware. Any features described may also be implemented together in an integrated logic device or separately as discrete but interoperable logic devices. If implemented in software, the techniques may be realized at least in part by a non-transitory processor-readable storage medium (such as the memory 206) comprising instructions (such as instructions 208 or other instructions accessible by the image signal processor 212) that, when executed by one or more processors (such as the processor 204 or the image signal processor 212), performs one or more of the methods described above. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the example implementations disclosed herein may be executed by one or more processors, such as the processor 204 or the image signal processor 212 that may be provided within the camera controller 210. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. Additionally, the functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated. Accordingly, the disclosure is not limited to the illustrated examples, and any means for performing the functionality described herein are included in aspects of the disclosure.

What is claimed is:

1. A device configured to detect camera tampering, comprising:
one or more processors; and
a memory coupled to the one or more processors and including instructions that, when executed by the one or more processors, cause the device to:
determine a first sum vector of intensity values from a first image frame captured by a camera at a first time;
determine a second sum vector of intensity values from a second image frame captured by the camera at a second time after the first time;
compare the first sum vector to the second sum vector; and
detect a tampering of the camera based on the comparison.

2. The device of claim 1, wherein the instructions further cause the device to:
divide the first sum vector into M segments, wherein M is an integer greater than 1; and
divide the second sum vector into M segments, wherein each of the M segments of the second sum vector corresponds to a different one of the M segments of the first sum vector and is the same size as the corresponding segment of the first sum vector;
wherein comparing the first sum vector to the second sum vector comprises comparing one or more segments of the second sum vector to corresponding segments of the first sum vector.

3. The device of claim 2, wherein the instructions further cause the device to identify each segment of the first sum vector as a flat field segment or a non-flat field segment;
wherein comparing one or more of the segments of the second sum vector to corresponding segments of the first sum vector comprises comparing each of the non-flat field segments of the first sum vector to the corresponding segment of the second sum vector.

4. The device of claim 3, wherein the instructions for comparing each of the non-flat field segments of the first sum vector to the corresponding segment of the second sum vector further cause the device to:
identify each of the corresponding segments of the second sum vector as a flat field segment or a non-flat field segment; and
compare the number of identified non-flat field segments of the first sum vector to the number of identified non-flat field segments of the second sum vector, wherein detecting the tampering of the camera is based on the comparison of the number of identified non-flat field segments.

5. The device of claim 3, wherein the instructions for comparing each of the non-flat field segments of the first sum vector to the corresponding segment of the second sum vector cause the device to:
determine a difference between one or more values of a non-flat field segment of the first sum vector and the corresponding segment of the second sum vector;
sum the differences for the one or more values; and
compare the sum to a threshold, wherein detecting the tampering of the camera comprises determining a movement of the camera based on the comparison of the sum to the threshold.

6. The device of claim 2, wherein:
the first sum vector and the second sum vector are row sum vectors; and
the instructions further cause the device to:
determine a first column sum vector of intensity values from the first image frame;
determine a second column sum vector of intensity values from the second image frame;
divide the first column sum vector into N segments, wherein N is an integer greater than 1;
divide the second column sum vector into N segments, wherein each of the N segments of the second column sum vector corresponds to a different segment of the first column sum vector and is the same size as the corresponding segment of the first column sum vector; and
compare one or more segments of the second column sum vector to corresponding segments of the first column sum vector, wherein detecting the tampering of the camera is further based on the comparison of the one or more segments of the second column sum vector to the corresponding segments of the first column sum vector.

7. The device of claim 6, wherein the instructions further cause the device to:
identify each segment of the first row sum vector as a flat field segment or a non-flat field segment, wherein comparing one or more of the segments of the second row sum vector to corresponding segments of the first row sum vector comprises comparing each of the non-flat field segments of the first row sum vector to the corresponding segment of the second row sum vector; and
identify each segment of the first column sum vector as a flat field segment or a non-flat field segment, wherein comparing one or more of the segments of the second column sum vector to corresponding segments of the first column sum vector comprises comparing each of the non-flat field segments of the first column sum vector to the corresponding segment of the second column sum vector.

8. The device of claim 7, wherein:
the instructions for comparing each of the non-flat field segments of the first row sum vector to the corresponding segment of the second row sum vector causes the device to:
identify each of the corresponding segments of the second row sum vector as a flat field segment or a non-flat field segment; and
compare the number of identified non-flat field segments of the first row sum vector to the number of identified non-flat field segments of the second row sum vector;
the instructions for comparing each of the non-flat field segments of the first column sum vector to the corresponding segment of the second column sum vector causes the device to:
identify each of the corresponding segments of the second column sum vector as a flat field segment or a non-flat field segment; and
compare the number of identified non-flat field segments of the first column sum vector to the number of identified non-flat field segments of the second column sum vector;
the instructions for detecting the tampering of the camera based on the comparison causes the device to detect the tampering based on:
the comparison of the number of identified non-flat field segments of the first row sum vector to the number of identified non-flat field segments of the second row sum vector; and
the comparison of the number of identified non-flat field segments of the first column sum vector to the number of identified non-flat field segments of the second column sum vector.

9. The device of claim 7, wherein:
the instructions for comparing each of the non-flat field segments of the first row sum vector to the corresponding segment of the second row sum vector causes the device to:
determine a difference between one or more values of a non-flat field segment of the first row sum vector and the corresponding segment of the second row sum vector;
sum the differences for the non-flat field segment of the first row sum vector; and
compare the sum for the non-flat field segment of the first row sum vector to a first threshold;
the instructions for comparing each of the non-flat field segments of the first column sum vector to the corresponding segment of the second column sum vector causes the device to:
determine a difference between one or more values of a non-flat field segment of the first column sum vector and the corresponding segment of the second column sum vector;
sum the differences for the non-flat field segment of the first column sum vector; and
compare the sum for the non-flat field segment of the first column sum vector to a second threshold; and
the instructions for detecting the tampering of the camera based on the comparison causes the device to determine a movement of the camera based on:
the comparison of the sum for the non-flat field segment of the first row sum vector to the first threshold; and
the comparison of the sum for the non-flat field segment of the first column sum vector to the second threshold.

10. The device of claim 1, wherein the instructions for comparing the first sum vector to the second sum vector causes the device to:
determine a first volatility of at least a portion of the first sum vector;
determine a second volatility of at least a portion of the second sum vector; and
compare the first volatility to the second volatility, wherein detecting the tampering of the camera is based on the comparison of the first volatility to the second volatility.

11. The device of claim 1, further comprising the camera, wherein the instructions further cause the device to:
provide a notification in response to detecting the tampering of the camera.

12. A method to determine a tampering of a camera, comprising:
determining a first sum vector of intensity values from a first image frame captured by a camera at a first time;
determining a second sum vector of intensity values from a second image frame captured by the camera at a second time after the first time;
comparing the first sum vector to the second sum vector; and
detecting a tampering of the camera based on the comparison.

13. The method of claim 12, further comprising:
dividing the first sum vector into M segments, wherein M is an integer greater than 1; and
dividing the second sum vector into M segments, wherein each of the M segments of the second sum vector corresponds to a different one of the M segments of the first sum vector and is the same size as the corresponding segment of the first sum vector;
wherein comparing the first sum vector to the second sum vector comprises comparing one or more segments of the second sum vector to corresponding segments of the first sum vector.

14. The method of claim 13, further comprising:
identifying each segment of the first sum vector as a flat field segment or a non-flat field segment, wherein comparing one or more of the segments of the second sum vector to corresponding segments of the first sum vector comprises comparing each of the non-flat field segments of the first sum vector to the corresponding segment of the second sum vector.

15. The method of claim 14, wherein:
comparing each of the non-flat field segments of the first sum vector to the corresponding segment of the second sum vector comprises:
identifying each of the corresponding segments of the second sum vector as a flat field segment or a non-flat field segment; and
comparing the number of identified non-flat field segments of the first sum vector to the number of identified non-flat field segments of the second sum vector; and
detecting the tampering of the camera is based on the comparison of the number of identified non-flat field segments.

16. The method of claim 14, wherein comparing each of the non-flat field segments of the first sum vector to the corresponding segment of the second sum vector comprises:
determining a difference between one or more values of a non-flat field segment of the first sum vector and the corresponding segment of the second sum vector;
summing the differences for the one or more values; and
comparing the sum to a threshold, wherein detecting the tampering of the camera comprises determining a movement of the camera based on the comparison of the sum to the threshold.

17. The method of claim 13, wherein the first sum vector and the second sum vector are row sum vectors, the method further comprising:
determining a first column sum vector of intensity values from the first image frame;
determining a second column sum vector of intensity values from the second image frame;
dividing the first column sum vector into N segments, wherein N is an integer greater than 1;
dividing the second column sum vector into N segments, wherein each of the segments of the second column sum vector corresponds to a different segment of the first column sum vector and is the same size as the corresponding segment of the first column sum vector; and
comparing one or more segments of the second column sum vector to the corresponding segment of the first column sum vector;
wherein detecting the tampering of the camera is further based on the comparison of the one or more segments of the second column sum vector to the corresponding segment of the first column sum vector.

18. The method of claim 17, further comprising:
identifying each segment of the first row sum vector as a flat field segment or a non-flat field segment, wherein comparing one or more of the segments of the second row sum vector to corresponding segments of the first row sum vector comprises comparing each of the non-flat field segments of the first row sum vector to the corresponding segment of the second row sum vector; and
identifying each segment of the first column sum vector as a flat field segment or a non-flat field segment, wherein comparing one or more of the segments of the second column sum vector to corresponding segments of the first column sum vector comprises comparing each of the non-flat field segments of the first column sum vector to the corresponding segment of the second column sum vector.

19. The method of claim 18, wherein:
comparing each of the non-flat field segments of the first row sum vector to the corresponding segment of the second row sum vector comprises:
identifying each of the corresponding segments of the second row sum vector as a flat field segment or a non-flat field segment; and
comparing the number of identified non-flat field segments of the first row sum vector to the number of identified non-flat field segments of the second row sum vector;
comparing each of the non-flat field segments of the first column sum vector to the corresponding segment of the second column sum vector comprises:
identifying each of the corresponding segments of the second column sum vector as a flat field segment or a non-flat field segment; and
comparing the number of identified non-flat field segments of the first column sum vector to the number of identified non-flat field segments of the second column sum vector; and
detecting the tampering of the camera is based on:
the comparison of the number of identified non-flat field segments of the first row sum vector to the number of identified non-flat field segments of the second row sum vector; and
the comparison of the number of identified non-flat field segments of the first column sum vector to the number of identified non-flat field segments of the second column sum vector.

20. The method of claim 18, wherein:
comparing each of the non-flat field segments of the first row sum vector to the corresponding segment of the second row sum vector comprises:
determining a difference between one or more values of a non-flat field segment of the first row sum vector and the corresponding segment of the second row sum vector;
summing the differences for the non-flat field segment of the first row sum vector; and
comparing the sum for the non-flat field segment of the first row sum vector to a first threshold;
comparing each of the non-flat field segments of the first column sum vector to the corresponding segment of the second column sum vector comprises:
determining a difference between one or more values of a non-flat field segment of the first column sum vector and the corresponding segment of the second column sum vector;
summing the differences for the non-flat field segment of the first column sum vector; and
comparing the sum for the non-flat field segment of the first column sum vector to a second threshold; and
detecting the tampering of the camera comprises determining a movement of the camera based on:
the comparison of the sum for the non-flat field segment of the first row sum vector to the first threshold; and
the comparison of the sum for the non-flat field segment of the first column sum vector to the second threshold.

21. The method of claim 12, wherein:
comparing the first sum vector to the second sum vector comprises:
determining a first volatility of at least a portion of the first sum vector;
determining a second volatility of at least a portion of the second sum vector; and
comparing the first volatility to the second volatility; and
detecting the tampering of the camera is based on the comparison of the first volatility to the second volatility.

22. The method of claim 12, further comprising:
providing a notification in response to detecting the tampering of the camera.

23. A non-transitory computer-readable storage medium storing one or more programs containing instructions that, when executed by one or more processors of a device, cause the device to perform a number of operations comprising:
determining a first sum vector of intensity values from a first image frame captured by a camera at a first time;
determining a second sum vector of intensity values from a second image frame captured by the camera at a second time after the first time;
comparing the first sum vector to the second sum vector; and
detecting a tampering of the camera based on the comparison.

24. The non-transitory computer-readable storage medium of claim 23, wherein execution of the instructions further causes the device to perform operations further comprising:
dividing the first sum vector into M segments, wherein M is an integer greater than 1; and
dividing the second sum vector into M segments, wherein each of the M segments of the second sum vector corresponds to a different one of the M segments of the first sum vector and is the same size as the corresponding segment of the first sum vector;
wherein comparing the first sum vector to the second sum vector comprises comparing one or more segments of the second sum vector to corresponding segments of the first sum vector.

25. The non-transitory computer-readable storage medium of claim 24, wherein execution of the instructions further causes the device to perform operations further comprising:
identifying each segment of the first sum vector as a flat field segment or a non-flat field segment, wherein comparing one or more of the segments of the second sum vector to corresponding segments of the first sum vector comprises comparing each of the non-flat field segments of the first sum vector to the corresponding segment of the second sum vector.

26. The non-transitory computer-readable storage medium of claim 25, wherein execution of the instructions for comparing the first sum vector to the second sum vector causes the device to perform operations further comprising:
determining a first volatility of at least a portion of the first sum vector;
determining a second volatility of at least a portion of the second sum vector; and
comparing the first volatility to the second volatility, wherein detecting the tampering of the camera is based on the comparison of the first volatility to the second volatility.

27. A device configured to detect camera tampering, comprising:
means for determining a first sum vector of intensity values from a first image frame captured by a camera at a first time;
means for determining a second sum vector of intensity values from a second image frame captured by the camera at a second time after the first time;
means for comparing the first sum vector to the second sum vector; and
means for detecting a tampering of the camera based on the comparison.

28. The device of claim 27, further comprising:
means for dividing the first sum vector into M segments, wherein M is an integer greater than 1; and
means for dividing the second sum vector into M segments, wherein each of the M segments of the second sum vector corresponds to a different one of the M segments of the first sum vector and is the same size as the corresponding segment of the first sum vector;
means for identifying each segment of the first sum vector as a flat field segment or a non-flat field segment, wherein the means for comparing the first sum vector to the second sum vector comprises means for comparing each of the non-flat field segments of the first sum vector to the corresponding segment of the second sum vector.

29. The device of claim 28, wherein:
the means for comparing each of the non-flat field segments of the first sum vector to the corresponding segment of the second sum vector comprises:
means for identifying each of the corresponding segments of the second sum vector as a flat field segment or a non-flat field segment; and
means for comparing the number of identified non-flat field segments of the first sum vector to the number of identified non-flat field segments of the second sum vector; and
the means for detecting the tampering of the camera comprises means for detecting the tampering based on the comparison of the number of identified non-flat field segments.

30. The device of claim 27, wherein the means for comparing each of the non-flat field segments of the first sum vector to the corresponding segment of the second sum vector comprises:
means for determining a difference between one or more values of a non-flat field segment of the first sum vector and the corresponding segment of the second sum vector;
means for summing the differences for the one or more values; and
means for comparing the sum to a threshold, wherein detecting the tampering of the camera comprises determining a movement of the camera based on the comparison of the sum to the threshold.
